(19) United States
(12) Patent Application Publication
(10) Pub. No.: US 2026/0260016 A1
(43) Pub. Date: Sep. 3, 2026

(54) Systems and Methods for Generating Secure Anonymized Structured Data Matrices

(71) Applicant: Veeva Systems Inc., Pleasanton, CA (US)

(72) Inventors: Peter Gassner, Pleasanton, CA (US); Arno Sosna, Pleasanton, CA (US); Daniel Kallman, Foster City, CA (US); Ankit Prasad, Highlands Ranch, CO (US); Jason Kline, Hershey, PA (US); Yizhen Lu, Markham (CA); Mikyla Callaghan, Toronto (CA)

(73) Assignee: Veeva Systems Inc., Pleasanton, CA (US)

(21) Appl. No.: 19/553,725

(22) Filed: Mar. 2, 2026

Related U.S. Application Data
(60) Provisional application No. 63/764,860, filed on Feb. 28, 2025.

(51) Int. Cl. G06F 21/62

(52) U.S. Cl. CPC G06F 21/6254

(57) ABSTRACT

A computer-implemented method for generating anonymized structured data matrices preserving data integrity, comprising: receiving, by one or more processors from a plurality of customer relationship management systems operated by different organizations, interaction records documenting engagements between representatives and healthcare professionals, wherein each interaction record comprises engagement data indicating activities across a plurality of communication channels. The method comprises performing entity resolution by executing a matching algorithm that compares healthcare professional data against reference records stored in a master data management system to associate a globally unique identifier with each healthcare professional. The method comprises filtering interaction records to exclude records associated with healthcare professionals having an opt-out status indicator, computing composite engagement scores, grouping healthcare professionals into data structures each comprising a fixed number of healthcare professionals, computing aggregated channel metrics, generating an anonymized structured data matrix, and storing the matrix.

### CROSS-REFERENCE TO RELATED APPLICATIONS

This application claims priority U.S. Provisional Patent Application No. 63/764,860, filed on Feb. 28, 2025, entitled Systems and Methods for Generating Secure Cryptographic Data Bricks, which is hereby incorporated by reference herein for all purposes.

### TECHNICAL FIELD

The present disclosure relates generally to systems and methods that provide for generating secure cryptographic data matrices, wherein the data matrices include secure customer data, industry data and activity data.

### BACKGROUND

Within the life sciences sector, the Veeva Customer Relationship Management (CRM) ecosystem maintains a dominant market position, representing approximately 80% of industry utilization. This ecosystem captures an estimated 2 billion annual interactions between healthcare professionals (HCPs) and life sciences organizations (e.g., pharmaceutical sales representatives and medical science liaisons). Given its scale, this corpus constitutes a highly granular and comprehensive longitudinal dataset of HCP engagement and access patterns.

To leverage this unique dataset effectively and ethically, robust technical safeguards are required to maintain data integrity while ensuring regulatory privacy compliance. There is a critical necessity to prevent the re-identification or reverse engineering of sensitive data points related to the involved parties. Consequently, there exists a technical need for a system and method configured for the multi-layered anonymization and multi-dimensional aggregation of HCP-associated data that would enable optimized stakeholder engagement and strategic resource orchestration while rigorously protecting Personally Identifiable Information (PII).

### SUMMARY OF THE INVENTION

Embodiments disclosed in the present document provide a computer-implemented method for generating anonymized structured data matrices that prevent reverse engineering of individual entity activities while enabling comparative analysis of engagement patterns is provided. The method comprises receiving, by one or more processors from a plurality of customer relationship management systems operated by different organizations, interaction records documenting engagements between representatives of the organizations and healthcare professionals. Each interaction record comprises engagement data indicating activities across a plurality of communication channels including at least two of video calls, non-video calls, sent electronic messages, and opened electronic messages. The method further comprises performing, by the one or more processors, entity resolution by executing a matching algorithm that compares healthcare professional data extracted from the interaction records against reference records stored in a master data management system. The matching algorithm applies country-specific matching criteria to associate a globally unique identifier with each healthcare professional. The globally unique identifier enables aggregation of interaction records corresponding to a same healthcare professional across the plurality of customer relationship management systems. The method further comprises filtering, by the one or more processors, the interaction records to exclude records associated with healthcare professionals having an opt-out status indicator stored in the master data management system. The method further comprises segmenting, by the one or more processors, the healthcare professionals into segment groups based on at least one of geographic region and medical specialty. The method further comprises computing, by the one or more processors, a composite engagement score for each healthcare professional within each segment group by applying weighted values to the engagement data for each of the plurality of communication channels. The method further comprises sorting, by the one or more processors, the healthcare professionals within each segment group based on the composite engagement scores. The method further comprises grouping, by the one or more processors, the sorted healthcare professionals into data structures each comprising a fixed number of healthcare professionals having composite engagement scores within a threshold proximity. The fixed number is selected to prevent identification of individual healthcare professional engagement patterns. The method further comprises computing, by the one or more processors, aggregated channel metrics for each data structure. The aggregated channel metrics comprise an average engagement value for each of the plurality of communication channels calculated across the healthcare professionals within the data structure. The method further comprises generating, by the one or more processors, an anonymized structured data matrix associating each healthcare professional identifier with the aggregated channel metrics of the corresponding data structure in place of individual engagement values for the healthcare professional. The method further comprises storing the anonymized structured data matrix in a non-transitory computer-readable storage medium for access by the organizations to enable comparative analysis of engagement patterns without exposing individual healthcare professional engagement data or proprietary organizational engagement strategies.

According to other aspects of the present disclosure, the method may include one or more of the following features. Performing entity resolution may comprise applying a generic matching method for a first set of countries and applying country-specific matching methods for a second set of countries based on regional data availability and naming conventions. For healthcare professionals located in the United States, the matching algorithm may match a National Provider Identifier from the interaction records against National Provider Identifier records in the master data management system. The matching algorithm may compare account data from the customer relationship management systems against reference records using in-memory processing, and the account data may be discarded after processing. Performing entity resolution may further comprise executing a stamping process that applies the globally unique identifier to a designated field in each of the plurality of customer relationship management systems for accounts that were previously unmatched. The entity resolution may be performed on a periodic basis to maintain data accuracy and consistency across the plurality of customer relationship management systems. The master data management system may store reference data comprising names, addresses, contact information, medical specialty, license information, industry identifiers, and organizational affiliations for healthcare professionals. The fixed number of healthcare professionals in each data structure may be five. The threshold proximity may be determined such that healthcare professionals within each data structure have composite engagement scores that differ by less than a predetermined variance value. The method may further comprise determining, by the one or more processors, whether a data structure exceeds a customer concentration threshold indicating that engagement activity from a single organization exceeds a predetermined percentage of total engagement activity within the data structure, and blocking access to the aggregated channel metrics for the data structure in response to determining that the customer concentration threshold is exceeded. The method may further comprise determining, by the one or more processors, whether a data structure has interaction records from fewer than a minimum number of organizations, and blocking access to the aggregated channel metrics for the data structure in response to determining that the data structure has interaction records from fewer than the minimum number of organizations. Computing the composite engagement score may comprise applying a first weight to video call activities, a second weight to non-video call activities, a third weight to sent electronic message activities, and a fourth weight to opened electronic message activities. The method may further comprise computing, by the one or more processors, industry-level metrics at a country level and a specialty level by aggregating the engagement data across all healthcare professionals within the respective country or specialty. The method may further comprise freezing, by the one or more processors, the interaction records and the computed aggregated channel metrics at predetermined quarterly intervals to preserve data integrity for comparative analysis across different time periods. The method may further comprise generating, by the one or more processors, scrambled customer identifiers for each organization by applying a hash function to an anonymized customer identifier, wherein the scrambled customer identifiers are included in output files to maintain organization anonymity. The method may further comprise generating, by the one or more processors, a plurality of metric files at different granularities comprising at least a data structure metrics file, a country metrics file, a specialty metrics file, and a company metrics file. The method may further comprise enabling, by the one or more processors, an organization to compare the organization's engagement metrics against the aggregated channel metrics to identify healthcare professionals in high-activity data structures that are not present in the organization's customer relationship management system. Receiving the interaction records from the plurality of customer relationship management systems may occur at a standard interval.

According to another aspect of the present disclosure, a system for generating anonymized structured data matrices that prevent reverse engineering of individual entity activities while enabling comparative analysis of engagement patterns is provided. The system comprises one or more processors. The system further comprises a non-transitory computer-readable memory coupled to the one or more processors and storing instructions that, when executed by the one or more processors, cause the system to perform operations. The operations comprise receiving, via a plurality of interfaces to customer relationship management systems operated by different organizations, interaction records documenting engagements between representatives of the organizations and healthcare professionals. Each interaction record comprises engagement data indicating activities across a plurality of communication channels including at least two of video calls, non-video calls, sent electronic messages, and opened electronic messages. The operations further comprise performing entity resolution by executing a matching algorithm that compares healthcare professional data extracted from the interaction records against reference records stored in a master data management system. The matching algorithm applies country-specific matching criteria to associate a globally unique identifier with each healthcare professional. The globally unique identifier enables aggregation of interaction records corresponding to a same healthcare professional across the plurality of customer relationship management systems. The operations further comprise filtering the interaction records to exclude records associated with healthcare professionals having an opt-out status indicator stored in the master data management system. The operations further comprise segmenting the healthcare professionals into segment groups based on at least one of geographic region and medical specialty. The operations further comprise computing a composite engagement score for each healthcare professional within each segment group by applying weighted values to the engagement data for each of the plurality of communication channels. The operations further comprise sorting the healthcare professionals within each segment group based on the composite engagement scores. The operations further comprise grouping the sorted healthcare professionals into data structures each comprising a fixed number of healthcare professionals having composite engagement scores within a threshold proximity. The fixed number is selected to prevent identification of individual healthcare professional engagement patterns. The operations further comprise computing aggregated channel metrics for each data structure. The aggregated channel metrics comprise an average engagement value for each of the plurality of communication channels calculated across the healthcare professionals within the data structure. The operations further comprise generating an anonymized structured data matrix associating each healthcare professional identifier with the aggregated channel metrics of the corresponding data structure in place of individual engagement values for the healthcare professional. The operations further comprise storing the anonymized structured data matrix in a storage device for access by the organizations to enable comparative analysis of engagement patterns without exposing individual healthcare professional engagement data or proprietary organizational engagement strategies.

According to another aspect of the present disclosure, a non-transitory computer-readable medium storing instructions that, when executed by one or more processors, cause the one or more processors to perform operations is provided. The operations comprise receiving, from a plurality of customer relationship management systems operated by different organizations, interaction records documenting engagements between representatives of the organizations and healthcare professionals. Each interaction record comprises engagement data indicating activities across a plurality of communication channels. The operations further comprise performing entity resolution by executing a matching algorithm that compares healthcare professional data extracted from the interaction records against reference records stored in a master data management system to associate a globally unique identifier with each healthcare professional. The globally unique identifier enables aggregation of interaction records corresponding to a same healthcare professional across the plurality of customer relationship management systems. The operations further comprise filtering the interaction records to exclude records associated with healthcare professionals having an opt-out status indicator. The operations further comprise computing a composite engagement score for each healthcare professional by applying weighted values to the engagement data for each of the plurality of communication channels. The operations further comprise grouping the healthcare professionals into data structures each comprising a fixed number of healthcare professionals having composite engagement scores within a threshold proximity. The fixed number is selected to prevent identification of individual healthcare professional engagement patterns. The operations further comprise computing aggregated channel metrics for each data structure comprising an average engagement value for each of the plurality of communication channels calculated across the healthcare professionals within the data structure. The operations further comprise generating an anonymized structured data matrix associating each healthcare professional identifier with the aggregated channel metrics of the corresponding data structure in place of individual engagement values. The operations further comprise storing the anonymized structured data matrix for access by the organizations to enable comparative analysis of engagement patterns without exposing individual healthcare professional engagement data or proprietary organizational engagement strategies.

### BRIEF DESCRIPTION OF THE DRAWINGS

For a more complete understanding of the present application and its advantages, references are now made to the following description taken in conjunction with the accompanying drawings, in which like reference numbers indicate like features.

FIG. 1a illustrates an exemplary architecture for generating secure anonymized structured data matrices wherein the present invention may be implemented.

FIG. 1b illustrates an exemplary architecture for a matrix engine in FIG. 1A wherein the present invention may be implemented.

FIG. 2 illustrates an example block diagram of a computing device according to one embodiment of the present invention.

FIG. 3 illustrates an example high level block diagram of a user computing device according to one embodiment of the present invention.

FIG. 4 illustrates an example high level block diagram of a matrix engine server according to one embodiment of the present invention.

FIG. 5 illustrates an example flowchart of a method for generating secure anonymized structured data matrices according to one embodiment of the present invention.

FIG. 6a-6h illustrates example secure anonymized structured data matrices according to various embodiments of the present invention.

Although similar reference numbers may be used to refer to similar elements for convenience, it can be appreciated that each of the various example embodiments may be considered to be distinct variations.

The present embodiments will now be described hereinafter with reference to the accompany drawings, which form a part thereof, and which illustrate example embodiments which may be practiced. As used in the disclosures and the appending claims, the terms “embodiment” and “example embodiment” do not necessarily refer to a single embodiment, although it may, and various example embodiments may be readily combined and interchanged, without departing from the scope or spirit of the present embodiments. Furthermore, the terminology as used herein is for the purpose of describing example embodiments only, and are not intended to be limitations. In this respect, as used herein, the term “in” may include “in” and “on,”

### DETAILED DESCRIPTION OF INVENTION

The detailed description set forth below is intended as a description of various configurations of the subject technology and is not intended to represent the only configurations in which the subject technology may be practiced. The appended drawings are incorporated herein and constitute a part of the detailed description. The detailed description includes specific details for the purpose of providing a thorough understanding of the subject technology. However, the subject technology is not limited to the specific details set forth herein and may be practiced without these specific details. In some instances, well-known structures and components are shown in block diagram form in order to avoid obscuring the concepts of the subject technology.

This disclosure arises from the realization that traditional approaches to data aggregation and sharing face challenges in balancing the utility of shared insights against the protection of confidential business information. Customer relationship management systems in the life sciences industry collect substantial volumes of interaction data documenting engagements between pharmaceutical company representatives and healthcare professionals. This data encompasses various communication channels including in-person meetings, video calls, telephone conversations, electronic mail exchanges, as well as speaker programs, advisory boards, and roundtables. The aggregated dataset across multiple pharmaceutical companies represents a comprehensive record of industry-wide engagement patterns with healthcare professionals.

Organizations within the life sciences sector have recognized the value of understanding industry-wide engagement trends to benchmark their own activities against broader patterns. Such comparative analysis can inform strategic decisions regarding resource allocation, channel selection, and engagement optimization. However, the underlying interaction data contains commercially sensitive information that, if disclosed in raw form, could reveal proprietary sales strategies, target customer lists, and competitive positioning of individual companies.

Simple aggregation techniques may fail to adequately protect against reverse engineering when the number of contributing entities is small or when activity is concentrated among a limited number of participants. Additionally, healthcare professionals have privacy interests in how their interaction data is collected, processed, and shared across organizations.

The healthcare industry operates under regulatory frameworks that impose requirements on data handling, including provisions for individuals to opt out of certain data processing activities. Systems that aggregate and share engagement data across multiple organizations face the challenge of respecting these opt-out preferences while maintaining the integrity and utility of the aggregated datasets.

Existing data aggregation approaches may also struggle with the challenge of creating meaningful comparison groups. Healthcare professionals vary substantially in their engagement patterns based on factors such as medical specialty, geographic location, and practice setting. Aggregation systems that fail to account for these variations may produce metrics that lack relevance for comparative analysis.

Furthermore, the integration of data across multiple customer relationship management systems presents technical challenges related to entity resolution and identity management. The same healthcare professional may appear in multiple systems under different identifiers, complicating efforts to create unified views of engagement activity. Systems that address these challenges while maintaining appropriate privacy protections and preventing competitive intelligence leakage would advance the state of data aggregation technology.

The current disclosure provides a technical solution for a technical problem in the field of electronic data processing and preservation of data integrity in data management systems. The present disclosure addresses these technical challenges through a computer-implemented system that generates anonymized structured data matrices by receiving interaction records from a plurality of customer relationship management systems, performing entity resolution using country-specific matching algorithms to associate a globally unique identifier with each healthcare professional across disparate systems, and grouping healthcare professionals into data structures each comprising a fixed number of individuals having composite engagement scores within a threshold proximity. The system computes aggregated channel metrics for each data structure, wherein the aggregated channel metrics comprise average engagement values calculated across the healthcare professionals within the data structure, and generates an anonymized structured data matrix that associates each healthcare professional identifier with the aggregated channel metrics of the corresponding data structure in place of individual engagement values. The system further prevents reverse engineering of proprietary organizational engagement strategies by blocking access to aggregated channel metrics for data structures that exceed a customer concentration threshold or that have interaction records from fewer than a minimum number of organizations. This approach enables organizations to perform comparative analysis of engagement patterns against industry benchmarks without exposing individual healthcare professional engagement data or the proprietary engagement strategies of contributing organizations.

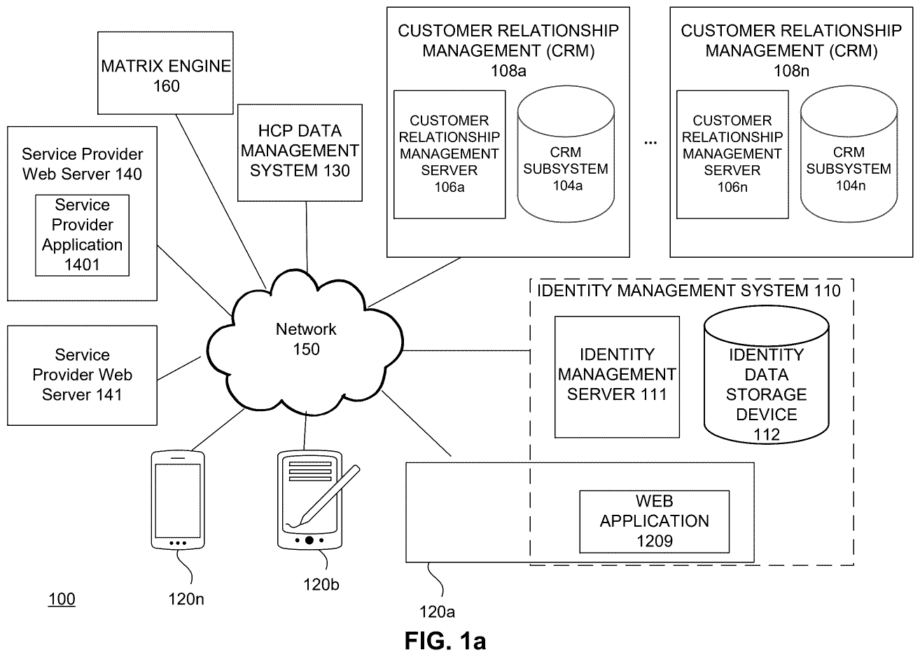

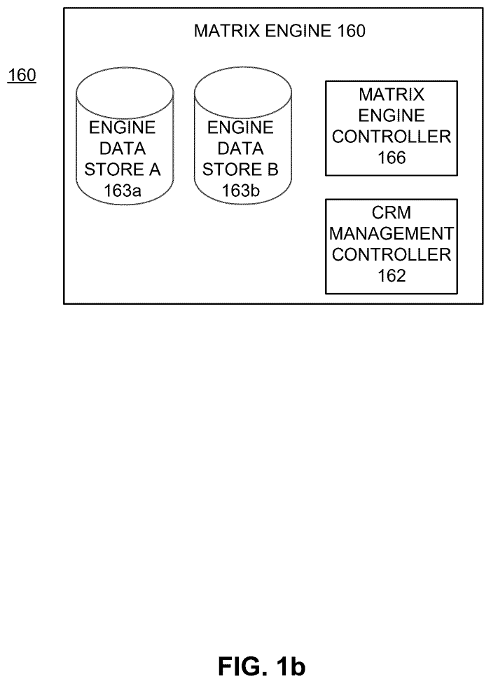

FIG. 1a illustrates an example high level block diagram of a secure anonymized data structure generation system architecture wherein the present invention may be implemented. As shown, the architecture 100 may include a Customer Relationship Management (CRM) 108a-n, an identity management system 110, a plurality of user computing devices 120a, 120b, . . . 120n, an HCP data management system 130, service provider web servers 140 and 141, and matrix engine 160, coupled to each other via a network 150. The network 150 may include one or more types of communication networks, e.g., a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

There may be a plurality of CRM 108a-n each corresponding to different organizations. The CRM 108a-n comprises a customer relationship management subsystem 104a-n and a customer relationship management server 106a-n. The customer relationship management server 106a-n may provide access to a customer relationship management subsystem 104a-n. In one embodiment, the customer relationship management subsystem 104a-n may be operated by a third party.

The customer relationship management subsystem 104a-n contains all professional information of health care providers (HCPs) that may be available to users, including contact information, licensing information, areas of practice, and specialties. In addition, the customer relationship management subsystem may also be capable of storing configurations regarding specific preferences, regulatory limitations and requirements, and other fields that will facilitate the generation of appropriate approved electronic communications, in general or on a by recipient basis. The configurations stored in the customer relationship management subsystem may define templates, content restrictions, and delivery parameters for electronic communications directed to health care providers. These preferences and/or requirements include both the preferences of the user (e.g., maintaining account lists) as well as the preferences of the enterprise (e.g., employers of the users) in various jurisdictions. In other examples, the customer relationship management subsystem may have a content management subsystem and may provide approved content and templates of approved communications.

In this embodiment, the customer relationship management subsystem 104a-n is capable of communication with multiple sources through the customer relationship management server 106a-n or through other channels to maintain a current and accurate collection of information regarding customer accounts. The interface with the multiple sources can be, for example, through an Applications Programming Interface or API, as the API interface will allow compatibility with a flexible array of third-party provider servers. The information being updated may include, but is not limited to, licensing information, area of practice, and location of the various customer contacts. In this manner, the customer relationship management subsystem 104a-n pulls the approved version of what represents an account or physician, which then pulls from multiple networks to ensure that the information regarding an account is up-to-date. The customer relationship management subsystem 104a-n may also be used to determine the type of domain an email communication is delivered through. A recipient in Spain may receive an email from “Companyx.es, whereas a recipient in Germany would receive the same email from “Companyx.ge.” This may allow for additional branding options for the company controlling and sending the electronic communications.

With further reference to the customer relationship management subsystem 104a-n, this system may be a cloud-based customer database that provides a central access to store and distribute consistent data across customer companies as well as their possible third-party partners and agencies that are used to keep this data updated. This system can provide standard data formats and provide an easy and automated way for customers (e.g. pharmaceutical companies) and/or users (e.g. pharmaceutical reps) to have access to coordinated and frequently updated CRM data and to use that coordinated data for sending approved electronic communications in accordance with the system described herein. Within the customer relationship management subsystem 104a-n, customer accounts may be assigned a set of alignment rules which determine specific pieces of content that are available for use from the controlled content repository 102.

The user computing devices 120a-120n may be any machine or system that is used by a user to access the service provider web servers 140 and 141 via the network 150, and may be any commercially available computing devices including laptop computers, desktop computers, mobile phones, smart phones, tablet computers, netbooks, and personal digital assistants (PDAs).

The first service provider web server 140 may host a first service provider website, and the second service provider web server 141 may host a second service provider website.

The identity management system 110 may have an identity management server 111 and an identity data storage device 112. The identity management server 111 is typically a remote computer system accessible over a remote or local network, such as the network 150. A web application (e.g., 1209) process may be active on one or more user computing devices (e.g., 120a), and the corresponding server process may be active on identity management server 111. The web application process and the corresponding server process may communicate with each other and with the HCP data management system 130 and the service provider web server 140 over the network 150, thus providing distributed functionality. The identity management server 111 may enable display of an identity management button on a webpage of the service provider website, and enable display of a user interface on a user computing device to allow an HCP user to register for the identity management service and provide profile information and login information. The identity management server 111 may communicate with the service provider web server 140 and the HCP data management system 130 to verity the HCP user and authenticate the HCP user to use the services provided by the service provider website.

The identity management system 110 may implement an Authoritative Data Source (ADS) and offer data from an Authoritative Source. Authoritative Data Source may be an information technology system designed to ensure the veracity of authoritative data, e.g., the HCP data management system 130. Authoritative Source(s) may be a legally recognized entity that produces/manages/develops the data asset itself. Authoritative Data may be the net result of sourcing, storing and managing electronic data, and the actual data produced by the authoritative source and managed by the ADS.

HCP Profile attributes, License, National/Regional Identifier, and address data are available from an authoritative source. Changes in demographic data, profile data, license, or other identifier data may be validated and updated on an ongoing basis. Records and details requiring suppression may be accounted for. Anomalies may occur among data sources, and data validity may be maintained by the comparison of data elements across multiple, authoritative sources. Administrators of the data source may research, remedy, and resolve any data discrepancies. Data records may be routinely compared against public records and other authoritative sources to ensure all information is complete and accurate.

There may be multiple CRMs 108a-n, each corresponding to a different organization. The same HCP may exist on multiple CRM subsystems 104a-n. Because each CRM subsystem 104a-n is associated with a given organization with different standards and processes, there is nothing linking the same HCP across multiple organizations. The data input into a CRM subsystem 104a-n may be input by the organization, or input by a third party vendor. A National Provider Identifier (NPI) exists in the US, which is a Health Insurance Portability and Accountability Act (HIPAA) Administration Simplification Standard that is a unique identification number for covered health care providers. However, matching an NPI with a last name is only available for the US because Europe and other global regions do not have this unique identifier available. The created globally unique identifier (GUID) is a unique ID for the HCP's identity that allows the association of data from the same HCP across multiple CRM subsystems to be collated.

When identifying an HCP, a standard set of basic information (e.g., licenses, address, name) from CRM 108a-n is retrieved from the CRM subsystem 104a-n. There may be rules and restrictions on the basic information available for retrieval. The standard set of basic information is compared to a master data management system (e.g., 130), which may store global reference data of HCPs and organizations. The master data management system may contain reference data including names, addresses, contact information, email, specialty, compliance data (license information and industry identifiers), and affiliations. Based on a series of checks, a match for the HCP may be identified in the master data management system to subsequently retrieve an associated HCP GUID stored in the master data management system. The series of checks may vary based on region or country. For instance, due to the nuances of each country, last name might be an effective filter to check for correspondence of an HCP in the US, but because Sweden has more people with the same last name, last name might not be as an effective check. There may be a generic matching method and then country specific matching methods due to the nuances in certain regions. For instance, NPI is great for matching doctors names but it doesn't work for Europe where NPI doesn't exist. Similarly, Switzerland might have a lot of doctors with the same last name, so the standard matching methods need a more rigorous process.

The license information stored in the reference data may include license numbers, licensing jurisdictions, license types, license status, and license expiration dates for each healthcare professional. The license information may be sourced from licensing boards and regulatory authorities in each jurisdiction where the healthcare professional holds a license to practice. The reference data may store historical license information to track changes in license status over time, including license renewals, suspensions, revocations, and reinstatements. The license information may be periodically re-validated against authoritative sources to ensure that the reference data reflects current license status.

The industry identifiers stored in the reference data may include National Provider Identifiers for healthcare professionals in the United States, as well as equivalent national or regional identifiers used in other countries. The industry identifiers may also include identifiers assigned by professional associations, specialty societies, hospital systems, and other organizations that maintain healthcare professional registries. The reference data may store multiple industry identifiers for each healthcare professional to support matching against records from different data sources that may use different identifier systems.

The organizational affiliations stored in the reference data may include healthcare organizations, hospital systems, medical groups, academic institutions, and other entities with which each healthcare professional is associated. The organizational affiliation data may include the healthcare professional's role or position within each affiliated organization, such as attending physician, department chair, or medical director. The reference data may store current and historical organizational affiliations to track changes in healthcare professional employment and practice arrangements over time.

Functioning as a trusted Identity Provider (IdP), the identity management system 110 may authenticate HCPs and provide identity assertions using widely used protocols, e.g., Security Assertion Markup Language (“SAML”) v2.0 and OpenID Connect 1.0. An identity assertion is in the form of a token and is used by a service provider (including third party service providers) to grant access to various services.

The process begins when the service provider website (e.g., customer. com) redirects the HCP browser to a login page Uniform Resource Locator (URL) hosted by the identity management system 110. URL query parameters indicate the type of access token returned after authentication. The login page captures the username and password, and enforces authentication protections, such as limiting the number of failed password attempts. Once the HCP is authenticated, the identity management system 110 may begin authentication token flow following a token exchange protocol, e.g., OpenID Connect 1.0 Provider or SAML 2.0 Identity Provider.

As detailed in the SAML v2.0 specification, the system requires knowledge of the service provider's public certificate file, the unique name of the service provider (Issuer ID), and a post back URL. This information is collected during registration. At a minimum, the system supports the IdP initiated single sign-on flow.

The identity data storage device 112 may store data for identity management, including physician professional information (e.g., name, specialty, license information, affiliated health care organization (“HCO”), and contact information at the affiliated HCO), HCP profile information, login information and other information for verifying the HCP. It should be understood that the identity data storage device 112 may store data for other industries.

In one implementation, the identity data storage device 112 may be a relational database that masters the HCP's identity and related information such as verified email addresses and phone numbers, license information, and related external identifiers.

In one embodiment, the identity management system 110 may be a multi-tenant system where various elements of hardware and software of the system 110 may be shared by one or more customers, or service providers. For instance, a server may simultaneously process requests from a plurality of customers, and a database table may store rows for a plurality of customers.

In one embodiment, the identity management system 110 may be a cloud database which runs on a cloud computing platform.

The HCP data management system 130 may store verified HCP professional information. Each HCP may be an account in the HCP data management system 130.

The HCP data management system 130 may cleanse, standardize and/or de-duplicate data from different sources to form the single, consolidated HCP data and store the HCP data. This may help to avoid using multiple and potentially inconsistent versions of the same data. Any changes to the HCP data will be displayed on a data steward interface, so that a data steward may check the changes and update the customer master data when the changes are verified.

In one implementation, the HCP data management system 130 is a master data management system (“MDM”). The system 130 may store customer master data, which may be many types of data used by the enterprise, e.g., accounts, addresses and reference data. In one implementation, the system 130 may store verified HCP and/or healthcare organization (“HCO”) information for a pharmaceutical company. In one example, the system 130 may store verified physician professional information of cardiologists in the U.S. compiled and/or purchased by a pharmaceutical company. Each HCP may be an account in the system 130. The system 130 may be implemented with any commercially available data storage devices.

In one implementation, the HCP data management system 130 is a relational database. It may be used both in the verification process to remotely proof (verify) users as HCPs and for periodic re-validation of HCPs that had previously been verified.

In one implementation, the HCP data management system 130 may be provided to the service providers by a data provider as a software as a service (“SaaS”). In addition, like the identity management system 110, the HCP data management system 130 may be a cloud based multi-tenant system.

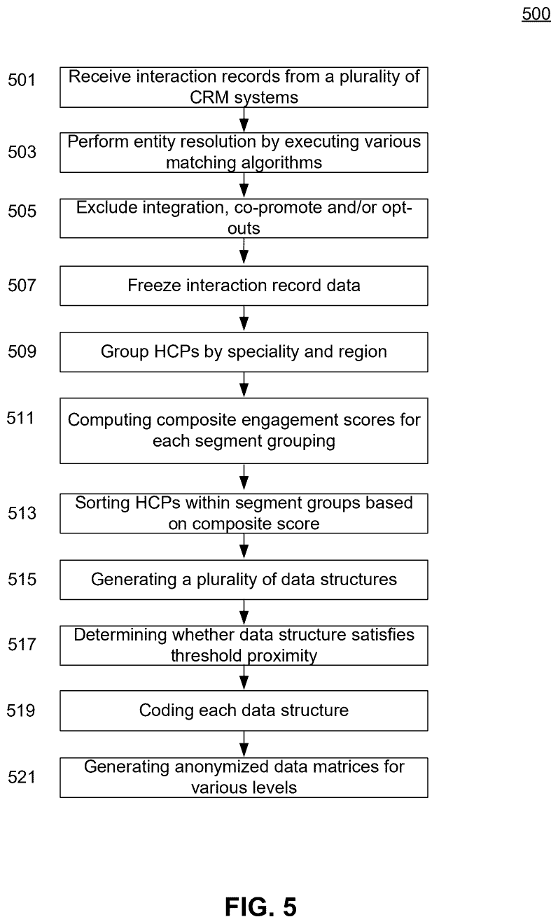

FIG. 1b illustrates an example high level block diagram of the matrix engine 160 in FIG. 1a. As depicted, matrix engine 160 may include an engine data store A 163a , engine data store B 163b, CRM management controller 162 and matrix engine controller 166. CRM management controller 162 may query and process interaction record retrieval from CRM 108a-n. Matrix engine controller 166 supports the generation of secure anonymized structured data matrices, as will be described in more detail in FIG. 5 below.

Engine data store A 163a may be a relational database serving as a storage layer for interaction records received from the plurality of customer relationship management systems 108a-n. Engine data store A 163a may provide transactional integrity through support for atomicity, consistency, isolation, and durability properties, ensuring interaction records are written atomically and consistently while preventing partial writes or data corruption during the data ingestion process. Concurrent read and write operations may be supported through locking mechanisms and transaction isolation levels, enabling ongoing data collection while analytical queries are executed against the stored data. Engine data store A 163a may utilize Structured Query Language (SQL) for data definition, data manipulation, and query operations, providing a standardized interface for interacting with stored interaction records. Indexes on frequently queried columns may be maintained to accelerate data retrieval operations and may enforce referential integrity constraints to ensure consistency of relationships between related data elements.

Engine data store 163b may be a high-performance, open-source analytical database (OLAP) designed for real-time analytics, sub-second queries and high-concurrency workloads. Engine data store 163b may use a distributed vectorized massively parallel processing (MPP) architecture in C++ to enable fast SQL analysis, supporting both real-time ingestion and ad-hoc queries. Query execution may be distributed across multiple processing nodes to achieve parallel computation of aggregation operations reducing query execution time compared to row-oriented database systems. Vectorized query execution that processes data in batches rather than row-by-row, improves computation efficiency for operations such as computing sums, averages, and counts across large datasets. Engine data store 163b may be optimized for low-latency analytical queries on large volumes of data, enabling aggregation operations that might require extended processing time in a transactional database to complete in significantly reduced time. Real-time data ingestion may provide near-instantaneous query results on freshly ingested data, enabling timely computation of aggregated channel metrics as new interaction records are received from customer relationship management systems 108a-n.

Matrix engine 160 may implement a dual database architecture (e.g., engine data store A 163a and engine data store B 163b) to support both ongoing data collection and frozen quarterly data sets. The dual database architecture may utilize a MySQL relational database (e.g., 163a) for transactional integrity and a StarRocks database (e.g., 163b) for fast analytical querying. The MySQL relational database may provide durable storage with transactional guarantees that ensure data consistency during write operations. The StarRocks database may provide optimized query performance for analytical operations that aggregate and summarize large volumes of interaction data.

Engine data store 163a (e.g., MySQL relational database) may serve as the primary storage layer for interaction records received from the plurality of customer relationship management systems. The transactional integrity provided by the MySQL relational database may ensure that interaction records are written atomically and consistently, preventing partial writes or data corruption during the data ingestion process. The MySQL relational database may support concurrent read and write operations, enabling ongoing data collection while analytical queries are executed against the stored data.

Engine data store 163b (e.g., StarRocks database) may serve as the analytical processing layer for computing aggregated channel metrics and generating output data files. The StarRocks database may be optimized for fast querying of large data sets, enabling aggregation operations that might require extended processing time in the MySQL relational database to complete in significantly reduced time. An aggregation operation that might take thirty minutes to execute in the MySQL relational database might complete in approximately one minute when executed in the StarRocks database due to the optimized query processing capabilities of the StarRocks architecture.

The system may maintain live databases for weekly data imports and frozen databases for locked quarterly data. The live databases may include a live Engine data store 163a and a live Engine data store 163b that receive ongoing updates as interaction records are extracted from customer relationship management systems on a weekly basis. The live databases may reflect the current state of interaction data, including records that have been added or modified since the previous extraction cycle. The live databases may be used for analysis, testing, and reporting purposes during the quarter while data collection is ongoing.

The frozen databases may include a frozen Engine data store 163a and a frozen Engine data store 163b that contain locked quarterly data sets. When the system freezes data at the end of a quarterly processing period, the interaction records and associated reference data for that quarter may be copied from the live databases to the frozen databases. Once copied to the frozen databases, the quarterly data set may not be modified, ensuring that the frozen data remains stable and consistent for all subsequent access and analysis operations.

The separation of live databases and frozen databases may enable the system to continue collecting and processing new interaction data while maintaining stable historical data sets for distribution. The live databases may receive weekly updates with new interaction records, changes to healthcare professional attributes, and other data modifications that occur during the ongoing quarter. The frozen databases may preserve the state of the data as it existed at the time of the quarterly freeze, unaffected by subsequent changes to the live data.

The frozen quarterly data sets may preserve data integrity for comparative analysis across different time periods by ensuring that the same source data is used whenever a particular quarterly data set is accessed or regenerated. When an organization downloads the anonymized structured data matrix for a particular quarter, the system may retrieve the data from the frozen databases associated with that quarter. If the organization downloads the same quarterly data set at a later date, the system may retrieve the data from the same frozen databases, ensuring that the organization receives identical results regardless of when the download occurs.

The preservation of data integrity through frozen quarterly data sets may ensure consistent comparisons when customers join at different times. A customer organization that joins the system several months after a particular quarter has ended may still access the anonymized structured data matrix for that quarter. The system may generate the customer-specific metrics using the frozen data set for that quarter, ensuring that the customer receives metrics computed from the same source data that was used for other customers who accessed the data earlier. The frozen data approach may enable apples-to-apples comparisons between customers who access the data at different times.

The preservation of data integrity through frozen quarterly data sets may also ensure consistent comparisons when healthcare professional attributes, such as specialty, change over time. Healthcare professional specialty designations may change in the master data management system as healthcare professionals obtain additional certifications, change practice focus, or update their professional information. When a healthcare professional's specialty changes after a quarterly data set has been frozen, the change may be reflected in subsequent quarterly data sets but may not affect the frozen data set for previous quarters. The healthcare professional may remain classified under the original specialty designation in the frozen historical data, ensuring that the segment group composition and aggregated metrics remain consistent with the original computation.

The frozen databases may store the healthcare professional attributes as they existed at the time of the quarterly freeze, including country, specialty, and other classification attributes used during segmentation and grouping operations. By preserving the original attribute values in the frozen databases, the system may ensure that any regeneration of the quarterly data set produces results consistent with the original generation. If the system needs to regenerate a quarterly data set due to opt-out processing or other requirements, the regeneration may use the frozen attribute values rather than current attribute values from the master data management system.

The dual database architecture may support efficient processing of both transactional operations and analytical operations. Engine data store 163a (e.g., MySQL relational database) may handle the transactional workload of receiving and storing interaction records from multiple customer relationship management systems on a weekly basis. Engine data store 163b (e.g., StarRocks database) may handle the analytical workload of computing aggregated channel metrics across large populations of healthcare professionals. The separation of transactional and analytical workloads across different database systems may enable each system to be optimized for its specific workload characteristics.

The movement of data from the live databases to the frozen databases at quarterly intervals may involve copying the relevant interaction records and reference data to the frozen storage layer. The copying operation may create a complete snapshot of the quarterly data that can be accessed independently of the live databases. The frozen databases may be configured with read-only access to prevent inadvertent modification of the locked quarterly data. The read-only configuration may provide an additional safeguard to ensure that frozen data sets remain stable and consistent over time.

The frozen quarterly data sets may be retained for a defined retention period to support historical analysis and comparative reporting. The retention period may be configured to maintain two years of historical quarterly data, enabling organizations to analyze engagement trends and patterns across multiple years. As new quarterly data sets are frozen and added to the frozen databases, older quarterly data sets that exceed the retention period may be archived or removed according to data retention policies.

The production version of the code that performs metric calculations may also be versioned and associated with each frozen quarterly data set. Matrix engine 160 may maintain the specific version of the calculation code that was used to generate each quarterly data set, enabling regeneration of the data set using the same computational logic if needed. The versioning of calculation code may ensure that any regeneration produces results consistent with the original generation, even if the calculation code has been updated for subsequent quarters.

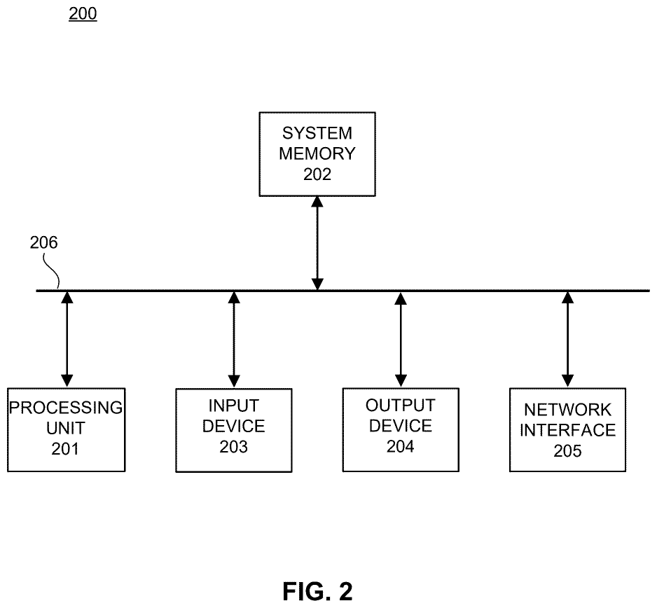

FIG. 2 illustrates an example block diagram of a computing device 200 which can be used as the user computing devices 120a-120n, and the identity management server 111 in FIG. 1a. The computing device 200 is only one example of a suitable computing environment and is not intended to suggest any limitation as to scope of use or functionality. The computing device 200 may include a processing unit 201, a system memory 202, an input device 203, an output device 204, a network interface 205 and a system bus 206 that couples these components to each other.

The processing unit 201 may be configured to execute computer instructions that are stored in a computer-readable medium, for example, the system memory 202. The processing unit 201 may be a central processing unit (CPU).

The system memory 202 typically includes a variety of computer readable media which may be any available media accessible by the processing unit 201. For instance, the system memory 202 may include computer storage media in the form of volatile and/or nonvolatile memory such as read only memory (ROM) and/or random access memory (RAM). By way of example, but not limitation, the system memory 202 may store instructions and data, e.g., an operating system, program modules, various application programs, and program data.

A user can enter commands and information to the computing device 200 through the input device 203. The input device 203 may be, e.g., a keyboard, a touchscreen input device, a touch pad, a mouse, a microphone, and/or a pen.

The computing device 200 may provide its output via the output device 204 which may be, e.g., a monitor or other type of display device, a speaker, or a printer.

The computing device 200, through the network interface 205, may operate in a networked or distributed environment using logical connections to one or more other computing devices, which may be a personal computer, a server, a router, a network PC, a peer device, a smart phone, or any other media consumption or transmission device, and may include any or all of the elements described above. The logical connections may include a network (e.g., the network 150) and/or buses. The network interface 205 may be configured to allow the computing device 200 to transmit and receive data in a network, for example, the network 150. The network interface 205 may include one or more network interface cards (NICs).

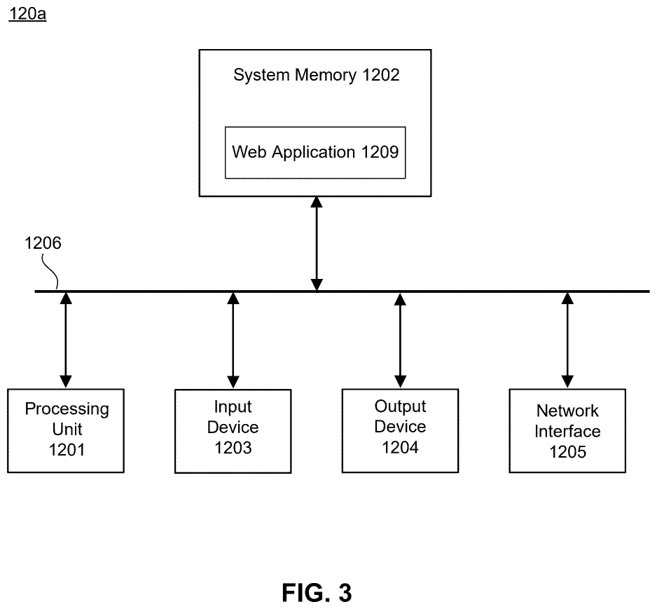

FIG. 3 illustrates an example high level block diagram of a user computing device (e.g., 120a) wherein the present invention may be implemented. The user computing device 120a may be implemented by the computing device 200 described above, and may have a processing unit 1201, a system memory 1202, an input device 1203, an output device 1204, and a network interface 1205, coupled to each other via a system bus 1206. The system memory 1202 may store a mobile-ready web application 1209 that supports the following processes:

Sign-In. The user may enter their credentials to ‘sign-in’ or start the registration process on a sign-in page. Should the user successfully sign-in, this process will handoff an OpenID Connect (“OIDC”) ID and access token to the service provider/relying party.

Registration. Process by which the user may create an identity within the identity data storage device 112. The identity may be an identity record identifying the user and comprise one main record and one or more related records. This can be done with without identity verification, i.e. the user can remain simply as a ‘registered user’ choosing not to elevate their identity to that of a verified HCP. A required part of this process is the capture and verification of a valid email inbox.

Verification. Process by which the user may verify that the identity within the identity data storage device 112 either as a medically licensed or non-medically licensed HCP. If the user chooses to go through this process, a license or national identifier may additionally be captured from the user based on the country in which he/she resides (also captured from the user). Using the last name and the appropriate identifier, the verification process will search for an exact match in the HCP data management system 130.

Client Authorization (OIDC/OAuth2). This authorization process entails checking each sign-in request made on behalf of a web-portal or mobile application (client application) to see if the user has authorized the client application to access their identity and related information. The identity may be used to enable these checks and maintain user-granted permissions for each client application attempting to access the user's identity.

The web application 1209 may enable self-service password reset, whereby a registered user can perform a self-service password reset via email, i.e. an email verification code is sent to the verified email inbox registered as a part of the user's identity.

The web application 1209 may support event tracking. Each sign-in, registration, verification, password reset process will generate an event record capturing all relevant information.

The web application 1209 may also enable customer-based customization, which may allow each customer to specify a customer logo that is displayed throughout each process facilitated by the identity management system 110, i.e. sign-in, registration, verification etc.

The exchange of identity claims between the identity management system 110 (including the identity management server 111, the identity data storage device 112 and the web application 1209) and the service provider web server 140 may be facilitated with APIs, e.g., OpenId Connect 1.0 APIs. An Authorization Code Flow is a process in the OpenId Connect 1.0 specification that dictates how a service provider application 1401 in the service provider web server 140 can access identity claims about the user (http://openid.net/specs/openid-connect-core-1_0.html#CodeFlowAuth). An ID/Access Token Endpoint is an API endpoint used by the service provider application 1401 to ultimately retrieve ID and access tokens in the form of JSON Web Token (JWT). This endpoint conforms to the OpenId Connect specification and is used within the broader Authorization Code Flow process specification. A UserInfo Endpoint may be a standard endpoint that exposes additional information about the user stored in the HCP data management system 130. The access token may be used to access information from this endpoint, and the endpoint conforms to the OpenId Connect specification.

The HCP interacts with the identity management system 110 by undergoing a registration process and creating login credentials. This action results in the creation of an identity in the identity data storage device 112.

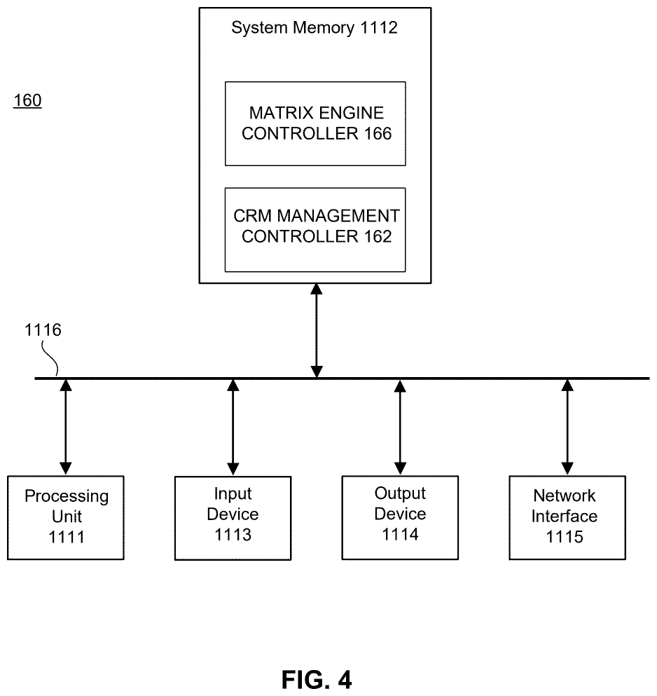

FIG. 4 illustrates an example high level block diagram of the matrix engine 160 according to one embodiment of the present invention. The matrix engine 160 may be implemented by the computing device 200, and may have a processing unit 1111, a system memory 1112, an input device 1113, an output device 1114, and a network interface 1115, coupled to each other via a system bus 1116. The system memory 1112 may store matrix engine controller 166 and CRM management controller 162, which controls the process to be discussed with reference to FIG. 5.

FIG. 5 illustrates an example flowchart of a method of generation of secure anonymized structured data matrices according to one embodiment of the present invention. The process may start at 501.

At 501, the matrix engine 160 receives interaction records from customer relationship management systems 108a-n. In some implementations, CRM management controller 162 may query and receive interaction records from a plurality of customer relationship management subsystems 104a . . . 104n. Each customer relationship management 108 a-b may be associated with and/or operated by a different organization. The interaction records may document engagements between representatives of the organizations and healthcare professionals. The plurality of customer relationship managements 108a . . . 108n may be operated by pharmaceutical companies, biotechnology firms, medical device manufacturers, or other life sciences organizations that employ representatives to engage with healthcare professionals. Each customer relationship management subsystem 104a . . . 104n may store records of interactions conducted by representatives associated with the respective organization.

CRM management controller 162 may receive the interaction records via a plurality of interfaces to the customer relationship managements 108a . . . 108n operated by the different organizations. The interfaces may include application programming interfaces that enable programmatic access to interaction data stored in each customer relationship management system. In some cases, the interfaces may utilize a customer relationship management console architecture that provides secure login access to customer relationship management instances. The customer relationship management console may store records for each customer relationship management environment, associating each environment with a customer identifier and administrative login credentials. The customer relationship management console may authenticate access requests and establish secure sessions for data extraction without exposing credentials to external systems.

In some implementations, receiving the interaction records from the plurality of customer relationship management systems may occur at a standard interval. The standard interval may be weekly, such that interaction records generated during each week are extracted and processed in a subsequent extraction cycle. The weekly extraction schedule may enable accumulation of sufficient interaction data for meaningful analysis while maintaining reasonable currency of the extracted information. In some cases, the standard interval may be daily for certain customer relationship management systems or certain types of interaction records. The standard interval may be configured based on data volume, processing capacity, and analytical requirements.

Each interaction record may comprise engagement data indicating activities across a plurality of communication channels. The plurality of communication channels may include at least two of video calls, non-video calls, sent electronic messages, and opened electronic messages. The engagement data may indicate the type of communication channel used for each interaction, the date and time of the interaction, the representative who conducted the interaction, and the healthcare professional who participated in the interaction.

In one implementation, the plurality of communication channels may also include events data documenting field-initiated engagements beyond individual representative interactions. The events data may encompass multiple field-initiated event types including speaker programs, advisory boards, roundtables, and other fee-for-service engagements conducted by organizations with healthcare professionals. Speaker programs may include educational presentations, peer-to-peer discussions, and promotional events where healthcare professionals present information about therapeutic products to other healthcare professionals. Advisory boards may include meetings where organizations convene groups of healthcare professionals to provide guidance on product development, clinical trial design, or commercial strategy. Roundtables may include smaller group discussions focused on specific therapeutic areas, treatment protocols, or emerging clinical evidence. Fee-for-service engagements may include consulting arrangements, market research participation, and other compensated activities involving healthcare professionals. The events data may include attendance tracking information indicating which healthcare professionals attended each event, enabling aggregation of event participation across multiple organizations. The events data may further include event classification attributes such as event type, event size indicating the number of attendees, and promotional status indicating whether the event included approved closed loop marketing content. Promotional events may be categorized by industry segment, event type, and event size to enable comparative analysis of event-based engagement patterns. The events data may be integrated with the engagement data from other communication channels when computing the composite engagement score for each healthcare professional, with weighted values applied to event attendance activities in addition to video calls, non-video calls, sent electronic messages, and opened electronic messages. The inclusion of events data in the anonymized structured data matrix may enable organizations to compare event-based engagement patterns against industry benchmarks while maintaining the same privacy protections applied to other communication channels.

Activity types may be classified based on the communication channel associated with each interaction record. Non-video activities may include call channels except video call channels. Video activities may include engage calls where the call channel equals a video call channel identifier. Sent email activities may include sent email records documenting electronic messages transmitted to healthcare professionals. Opened email activities may include records indicating that a healthcare professional opened a previously sent electronic message. Events activities may include field-initiated engagement presentation channels.

Call activity may be tracked using call activity objects stored in the customer relationship management systems. The call activity objects may include fields indicating whether the associated account is a person account, the submission status of the call record, and a parent identifier linking the call to a healthcare professional record. Call activity metrics may be computed by counting distinct parent identifiers associated with submitted call records for person accounts. The distinct count of parent identifiers may represent the number of unique healthcare professionals contacted through call activities.

Email activity may be tracked using sent email objects and email activity objects stored in the customer relationship management systems. Sent email metrics may be computed by counting distinct identifiers associated with sent email records. Opened email metrics may be computed by summing open count values from email activity records, where the open count value indicates the number of times a healthcare professional opened a particular electronic message. The email activity objects may store engagement indicators such as open status, click status, and response status for each sent electronic message.

The extracted interaction data may be combined into a flat table structure that consolidates call activities and email activities from multiple customer relationship management systems. The flat table may store the date of each interaction, a user identifier for the representative who conducted the interaction, and a globally unique identifier for the healthcare professional who participated in the interaction. The flat table structure may facilitate efficient querying and aggregation of interaction data across multiple organizations and communication channels. System flatteners may be used to transform multi-dimensional structures (e.g., objects) into a single one-dimensional representation where each piece of data is presented in flat form.

In some implementations, additional data elements may be extracted for supplementary analytics. Remote meeting duration may be tracked for video call activities to enable analysis of engagement depth and time investment. Closed loop marketing content usage may be tracked to indicate whether representatives presented approved marketing content from a controlled content repository during call activities. The closed loop marketing content usage data may indicate that content was shown during an interaction without capturing the specific approved content that was presented. Email click data may be extracted to track healthcare professional engagement with links contained in sent electronic messages. The additional data elements may support extended analytical capabilities beyond the aggregated channel metrics computed for the anonymized structured data matrices.

At 503, matrix engine controller 166 may perform entity resolution by executing a matching algorithm that compares healthcare professional data extracted from the interaction records against reference records stored in a master data management system (e.g., HCP Data Management System 130). The entity resolution process may associate healthcare professional records from multiple customer relationship management systems with corresponding reference records to establish consistent identification across different data sources. The matching algorithm may analyze data fields extracted from the interaction records and compare the extracted data fields against authoritative reference data maintained in the master data management system.

The master data management system may store reference records comprising professional information for healthcare professionals. The reference records may include names, addresses, contact information, medical specialty designations, license information, industry identifiers, and organizational affiliations for healthcare professionals. The master data management system may cleanse, standardize, and de-duplicate data from different sources to form single consolidated healthcare professional data. Changes to the reference records may be displayed on a data steward interface for verification before updating customer master data. The data steward interface may enable human review of proposed changes to ensure accuracy and consistency of the reference records maintained in the master data management system.

The matching algorithm may apply country-specific matching criteria to associate a globally unique identifier with each healthcare professional. The country-specific matching criteria may account for variations in data availability, naming conventions, identifier systems, and regulatory requirements across different geographic regions. The globally unique identifier may enable aggregation of interaction records corresponding to a same healthcare professional across the plurality of customer relationship management systems. By associating a consistent globally unique identifier with each healthcare professional, the system may consolidate interaction data from multiple organizations that engage with the same healthcare professional through their respective customer relationship management systems.

In some cases, performing entity resolution may comprise applying a generic matching method for a first set of countries and applying country-specific matching methods for a second set of countries based on regional data availability and naming conventions. The generic matching method may utilize common data fields such as name, address, and specialty to identify potential matches between customer relationship management records and reference records. The generic matching method may be applied in countries where standardized healthcare professional identifiers are not widely available or where data formats vary across different data sources.

The country-specific matching methods may leverage regional identifier systems, local naming conventions, and jurisdiction-specific data sources to improve matching accuracy. For countries with established healthcare professional identifier systems, the matching algorithm may utilize the regional identifiers as primary matching criteria. The country-specific matching methods may account for variations in name ordering, character sets, address formats, and specialty classification systems that differ across geographic regions.

An identity management system (e.g., identity management system 110) may support healthcare professional registration for capturing basic information to create login credentials and a digital identity. The identity management system may support healthcare professional verification as an optional country-specific process to verify the healthcare professional as licensed or non-licensed. The identity management system may provide identity and authentication via an authentication application programming interface and username and password management. The identity management system may maintain single identifier values for each healthcare professional across all healthcare professional-facing services. The identity management system may leverage authoritative healthcare professional data for verification and license information updates.

An identity data storage device (e.g., 112) may store data for identity management including physician professional information. The physician professional information may include name, specialty, license information, affiliated health care organization, and contact information at the affiliated health care organization. The identity data storage device may store healthcare professional profile information, login information, and other information for verifying the healthcare professional. The identity data storage device may maintain verified email addresses, phone numbers, license information, and related external identifiers associated with each healthcare professional.

In some implementations, matrix engine controller 166 may create translations of fields in individual customer relationship management subsystems 104a-n for each customer to facilitate consistent data processing across disparate data sources. Each customer relationship management subsystem 104a-n may individually input specialty designations for healthcare professionals using varying formats, including differences in casing, abbreviations, spelling variations, and formatting conventions. For example, one customer relationship management subsystem may store a specialty as “diabetes specialist”, whereas another may store the same specialty as “endocrinologist”. In another example, one customer relationship management system may store a specialty as “CARDIOLOGY” while another may store the same specialty as “cardiology” or “Cardio” or “Cardiovascular Disease.” The system may map specialty designations from each customer relationship management subsystem to standardized specializations maintained in the identity management system or master data management system. The mapping process may involve creating translation tables that associate each unique specialty designation found in a customer relationship management subsystem 104a-n with a corresponding standardized specialty code from a common data architecture. The translation tables may be generated through automated matching algorithms that identify likely correspondences between non-standardized specialty designations and standardized specialty codes, with manual review and correction applied for ambiguous or unmatched designations. The mapping to standardized specializations may facilitate entity resolution by enabling consistent specialty-based segmentation and matching across customer relationship management systems that employ different specialty naming conventions. When the matching algorithm compares healthcare professional data extracted from interaction records against reference records stored in the master data management system, the standardized specialty codes may be used in place of the original non-standardized specialty designations to improve matching accuracy. The specialty translation process may be performed during data ingestion, such that interaction records are enriched with standardized specialty codes before being processed through the entity resolution and metric computation stages. The system may maintain the original specialty designations from each customer relationship management system in addition to the mapped standardized specialty codes to support auditing and troubleshooting of the translation process.

The entity resolution process may generate a mapping table that associates customer relationship management records with the globally unique identifier. The mapping table may contain a customer relationship management instance identifier, a customer relationship management record identifier, and the globally unique identifier for each matched healthcare professional. The mapping table may not store any other customer relationship management account data beyond the identifiers used for establishing the association. By storing the mapping relationship without retaining underlying account data, the system may maintain data minimization principles while enabling aggregation of interaction records across multiple customer relationship management systems.

The matching algorithm may compare account data from the customer relationship management systems 108a-n against reference records using in-memory processing. The account data may be loaded into memory for comparison against the reference records, and the account data may be discarded after processing is complete. The in-memory processing approach may enable efficient comparison of large volumes of account data while avoiding persistent storage of customer relationship management account information beyond the mapping table.

The entity resolution process may be performed on a periodic basis to maintain data accuracy and consistency across the plurality of customer relationship management systems 108a-n. The periodic execution may identify new healthcare professional records that have been added to customer relationship management systems 108a-n since the previous execution cycle. The periodic execution may also identify changes to existing healthcare professional records that may affect the mapping relationship. The results of the entity resolution process may be written back to the customer relationship management systems to enable customers to utilize the globally unique identifier for their own analytical and operational purposes.

In some implementations, for healthcare professionals located in the United States, the matching algorithm may match a National Provider Identifier from the interaction records against National Provider Identifier records in the master data management system (e.g., 130). The National Provider Identifier is a unique identification number assigned to healthcare providers in the United States by the Centers for Medicare and Medicaid Services. The National Provider Identifier serves as a standardized identifier that enables consistent identification of healthcare professionals across different data systems and organizations operating within the United States healthcare ecosystem.

The matching algorithm may extract National Provider Identifier values from interaction records stored in the customer relationship management systems. The extracted National Provider Identifier values may be compared against National Provider Identifier records maintained in the master data management system to identify corresponding reference records. When a National Provider Identifier from an interaction record matches a National Provider Identifier in the master data management system, the matching algorithm may associate the globally unique identifier from the matched reference record with the healthcare professional record in the customer relationship management system.

The system may use two main pieces of evidence to verify a healthcare professional identity: an address and license information. The address verification component may compare practice address information entered by or associated with the healthcare professional against address records maintained in the master data management system. The license information verification component may compare license identifiers or credentials entered by or associated with the healthcare professional against license records maintained in the master data management system. The combination of address verification and license verification may provide a multi-factor approach to establishing healthcare professional identity with increased confidence.

Standardized codes may be used to indicate how the healthcare professional identity has been verified. The standardized codes may distinguish between different verification methods such as National Provider Identifier matching, license verification, address verification, or combinations thereof. The standardized codes may be stored in association with each verified healthcare professional record to provide an audit trail of the verification method applied. The standardized codes may enable downstream processes to assess the confidence level associated with each identity verification based on the verification method employed.

A match may be made when the healthcare professional-entered license or identifier matches an active license in the master data management system and the healthcare professional-entered practice address reasonably matches the healthcare professional associated with the matched license. The active license requirement may ensure that the healthcare professional holds a current and valid license to practice in the relevant jurisdiction. The reasonable address match requirement may account for variations in address formatting, abbreviations, and minor discrepancies while confirming that the practice location corresponds to the licensed healthcare professional.

The reasonable address matching may employ address standardization and comparison techniques to evaluate similarity between the healthcare professional-entered practice address and the reference address associated with the matched license. Address standardization may normalize street names, directional indicators, unit designations, and postal codes to a common format before comparison. The comparison may calculate a similarity score based on matching address components and may consider the address to reasonably match when the similarity score exceeds a configured threshold. The address matching may also account for healthcare professionals who practice at multiple locations by comparing against all known practice addresses associated with the matched license record.

In some implementations, the matching algorithm may compare account data from the customer relationship management systems against reference records using in-memory processing. The in-memory processing approach may load healthcare professional account data extracted from the customer relationship management systems into volatile memory for comparison against reference records maintained in the master data management system. The in-memory processing may enable rapid comparison operations by avoiding disk-based storage access during the matching computation. The matching algorithm may execute comparison logic against the account data while the account data resides in memory, generating match results that associate customer relationship management records with corresponding reference records.

The account data may be discarded after processing is complete. Once the matching algorithm has completed comparison operations and generated the mapping associations between customer relationship management records and globally unique identifiers, the account data loaded into memory may be released and removed from the processing environment. The discarding of account data after processing may ensure that healthcare professional information extracted from customer relationship management systems is not retained beyond the duration of the matching operation. By discarding the account data after processing, the system may maintain data minimization principles and reduce the volume of healthcare professional information stored outside of the originating customer relationship management systems.

The in-memory processing and subsequent data discarding may provide a transient processing model where account data exists in the processing environment for the duration of the matching operation. The transient processing model may reduce data retention risks by limiting the time window during which account data is accessible outside of the customer relationship management systems. The matching results, comprising the mapping associations between customer relationship management record identifiers and globally unique identifiers, may be persisted while the underlying account data used to generate the matches is discarded.

In some cases, the matching algorithm may monitor application programming interface usage thresholds associated with each customer relationship management instance before initiating matching operations. The system may track application programming interface consumption levels for each customer relationship management instance to avoid exceeding usage limits that could impact normal customer relationship management operations. A threshold value may be configured to determine when matching operations should be deferred to avoid contributing to application programming interface exhaustion.

The matching algorithm may not run if a customer relationship management instance has consumed more than forty percent of the application programming interface limit associated with that instance. The forty percent threshold may provide a buffer to ensure that sufficient application programming interface capacity remains available for normal customer relationship management operations conducted by the organization operating the customer relationship management instance. When the application programming interface consumption level exceeds the forty percent threshold, the matching algorithm may skip the customer relationship management instance during the current matching cycle.

When matching is deferred due to application programming interface usage exceeding the threshold, the matching may be run at a later date when application programming interface usage is below the threshold. The system may schedule a subsequent matching attempt for customer relationship management instances that were skipped due to application programming interface consumption levels. The subsequent matching attempt may occur during a later time period when application programming interface usage has decreased below the forty percent threshold. The deferred matching approach may enable the system to complete entity resolution for all customer relationship management instances while respecting application programming interface usage constraints that protect normal customer relationship management operations.

The application programming interface usage monitoring may query usage statistics from the customer relationship management console or directly from the customer relationship management instances before initiating data extraction operations. The usage statistics may indicate the number of application programming interface calls consumed during a defined time period relative to the total application programming interface allocation for the customer relationship management instance. The matching algorithm may evaluate the usage statistics against the configured threshold and determine whether to proceed with matching operations or defer to a subsequent cycle.

In some implementations, performing entity resolution may further comprise executing a stamping process that applies the globally unique identifier to a designated field in each of the plurality of customer relationship management systems for accounts that were previously unmatched. The stamping process may write the globally unique identifier value to a designated identifier field within each customer relationship management system, enabling the organization operating the customer relationship management system to utilize the globally unique identifier for downstream analytical and operational purposes. The designated field may be a standardized field name that is consistent across customer relationship management systems to facilitate uniform data handling and integration.

The stamping process may be performed automatically on a quarterly basis following the completion of matching operations. The quarterly execution schedule may align with the periodic generation of anonymized structured data matrices, ensuring that customer relationship management systems contain current globally unique identifier values before interaction data is extracted for aggregation. The automatic execution may be triggered upon successful completion of the matching algorithm, initiating the stamping process without manual intervention. The quarterly cadence may provide a balance between maintaining current identifier associations and minimizing the frequency of write operations to customer relationship management systems.

The stamping process may update accounts that previously had a blank value in the designated identifier field. Accounts that already contain a globally unique identifier value in the designated field may be excluded from the stamping operation to preserve existing identifier associations. The selective update approach may ensure that the stamping process does not overwrite previously established identifier values that may have been verified through earlier matching cycles. By targeting accounts with blank identifier fields, the stamping process may incrementally expand the coverage of globally unique identifier associations as new healthcare professional accounts are added to customer relationship management systems or as matching accuracy improves over time.

The designated identifier field may store the globally unique identifier as a persistent attribute of each healthcare professional account record within the customer relationship management system. The persistent storage of the globally unique identifier within the customer relationship management system may enable the organization to reference the identifier in reports, queries, and integrations without requiring repeated access to external matching services. The designated field may be configured as a read-only field from the perspective of end users to prevent inadvertent modification of the globally unique identifier value after stamping.

Primary keys and other external identifiers for healthcare professionals in customer relationship management systems may be associated with the healthcare professional identity maintained in the master data management system. The association may link customer relationship management record identifiers, National Provider Identifiers, license numbers, and other external identifiers to the corresponding globally unique identifier. Every identifier from a customer relationship management system may carry the customer relationship management system identifier from which the identifier originated. The customer relationship management system identifier may enable the system to trace the source of each external identifier and maintain provenance information for the identifier associations.

The stamping process may generate a log of updated accounts indicating the customer relationship management instance, the account record identifier, and the globally unique identifier value that was applied. The log may provide an audit trail of stamping operations for troubleshooting, compliance, and data quality monitoring purposes. The log may be retained for a configured retention period to support historical analysis of stamping activity across customer relationship management systems.

In some implementations, the entity resolution may be performed on a periodic basis to maintain data accuracy and consistency across the plurality of customer relationship management systems. The periodic execution of entity resolution may occur on a quarterly schedule aligned with the generation of anonymized structured data matrices. In some cases, the entity resolution may be performed on an ad hoc basis based on operational needs, such as when a new customer relationship management system is onboarded or when data quality issues are identified that warrant immediate re-matching. The periodic entity resolution may identify new healthcare professional records that have been added to customer relationship management systems since the previous execution cycle, as well as changes to existing records that may affect matching relationships.

At 505, matrix engine controller 166 excludes integration, co-promote and/or opt-out data to ensure the integrity and accuracy of the aggregated data and computed metrics.

In some implementations, matrix engine controller 166 may filter the interaction records in the flat table to exclude records associated with healthcare professionals having an opt-out status indicator stored in the CRM subsystem 104a-b, or master data management system (e.g., 130). The opt-out status indicator may be set when a healthcare professional submits a request to be excluded from data aggregation activities. The opt-out request may be submitted through an online form that is processed by the master data management system. Upon processing of the opt-out request, the master data management system may update the opt-out status indicator associated with the healthcare professional record to indicate that the healthcare professional has opted out of data aggregation.

Matrix engine controller 166 may maintain a commitment to remove opted-out healthcare professionals from the data in the engine data store A and engine data store B within thirty days of receiving the opt-out request. The thirty-day commitment may provide a defined timeframe within which the matrix engine controller 166 processes opt-out requests and updates data sets to exclude the opted-out healthcare professional. During the thirty-day period, Matrix Engine Controller 166 may identify all data sets containing records associated with the opted-out healthcare professional and may initiate scrubbing operations to remove or obscure the healthcare professional's identifiers from those data sets.

The filtering process may prevent any organization from downloading data containing healthcare professionals who have opted out. Once the opt-out status indicator is set for a healthcare professional, subsequent data extraction and distribution operations may exclude interaction records associated with that healthcare professional. The filtering may be applied during the generation of new anonymized structured data matrices as well as during regeneration of previously generated data sets that remain available for download.

For previously generated data sets, matrix engine controller 166 may implement an automatic scrubbing framework that processes opt-out requests against historical data. When an opt-out request is received, the scrubbing framework may identify each previously generated data set that contains identifiers for the opted-out healthcare professional. The scrubbing framework may remove or overwrite the healthcare professional identifiers in those data sets and may regenerate the deliverable files for organization download. The scrubbing approach may preserve aggregated metrics while removing the ability to identify the opted-out healthcare professional within the data set.

In some cases, the scrubbing of previously generated data sets may overwrite the healthcare professional identifier with a data privacy indicator rather than removing the record entirely. For a data structure containing a fixed number of healthcare professionals, the scrubbing may replace the opted-out healthcare professional's identifier with text indicating data privacy while retaining the aggregated metrics computed for the data structure. The data structure may continue to reflect the same number of healthcare professionals and the same average engagement values, but the identifier for the opted-out healthcare professional may no longer be visible to organizations downloading the data.

The filtering of interaction records to exclude records associated with healthcare professionals having an opt-out status indicator may be applied during the data extraction and processing pipeline. Before interaction records are included in metric computations, the system may query the master data management system to retrieve current opt-out status indicators for healthcare professionals associated with the interaction records. Interaction records associated with healthcare professionals having an opt-out status indicator may be excluded from further processing, ensuring that opted-out healthcare professionals do not contribute to aggregated metrics or appear in output data files.

Interaction records for healthcare professionals may be limited to healthcare professionals who meet specified filtering criteria. The filtering criteria may include a requirement that the healthcare professional have a globally unique identifier in the master data management system (e.g., 130). The filtering criteria may include a requirement that the healthcare professional be matched in a customer relationship management system 108a-n, indicating that entity resolution has successfully associated the healthcare professional with a customer relationship management record. The filtering criteria may include a requirement that the healthcare professional have activity in the previous quarter, where the previous quarter corresponds to the matrixing quarter used for data structure generation. The filtering criteria may include a requirement that the healthcare professional not be labeled as an opt-out, as described above. The filtering criteria may include a requirement that the healthcare professional have a selected common data architecture specialty from a set of available specialties, such as sixty-seven available specialty designations.

Healthcare professional metrics may utilize the healthcare professional country from the master data management system (e.g., 130) rather than country information stored in customer relationship management systems 108a-n. The use of the master data management system country may provide consistent geographic attribution across interaction records from multiple customer relationship management systems that may store different country values for the same healthcare professional. Healthcare professional metrics may ignore co-promote users, where co-promote users are representatives associated with co-promotion arrangements between organizations. A co-promote user may be an individual engaged in a collaborative strategy between two or more organizations to promote a single product, or service. Including the co-promote user records would skew, or inflate the aggregate metrics.

Representative metrics may be delivered together with healthcare professional metrics for purchased countries. Interaction records for representatives may be limited to representatives who meet specified filtering criteria. The filtering criteria for representatives may include a requirement that the representative have a standard user type value, such as key account manager, sales, admin, or null. The filtering criteria may include a requirement that the representative have activity in the previous quarter at the time of metric calculation. The filtering criteria may include a requirement that the representative be aligned to a user country. Representative metrics may utilize the user country from the customer relationship management system. Representative metrics may ignore co-promote users and integration users.

Matrix engine controller 166 may implement an integration user detection algorithm that identifies users with usage patterns falling far outside the norm for their customer relationship management system. The integration user detection algorithm may analyze total activity volumes for each user and compare the activity volumes against expected ranges based on typical representative behavior. Users with total activity volumes that exceed expected ranges by a threshold amount may be flagged as potential integration users. The integration user detection algorithm may also analyze activity patterns to identify unusual spikes in activity that may indicate non-human data entry. A user who records a large number of interactions within a short time period may be flagged as a potential integration user based on the activity spike pattern.

The integration user detection may identify users who are not human representatives entering interaction data through normal customer relationship management usage. Integration users may include automated processes that load interaction data into customer relationship management systems through batch operations or application programming interface integrations. Integration users may include administrative accounts used by customer relationship management operations teams to perform bulk data operations. The integration user detection algorithm may flag users whose activity patterns suggest automated or bulk data entry rather than individual representative usage.

Users flagged by the integration user detection algorithm may be subject to manual review before exclusion from metric calculations. The manual review may examine the username associated with the flagged user to determine whether the username indicates a non-human account. Usernames that do not resemble person names may provide an indication that the account is an integration user rather than a human representative. The manual review may also examine the activity patterns associated with the flagged user to confirm that the patterns are consistent with automated or bulk data entry.

Following manual review, confirmed integration users may be marked for exclusion from representative metrics. A flag or indicator may be set on the user record to indicate that the user should be excluded from representative metric calculations. The exclusion may be applied during metric computation by filtering out interaction records associated with flagged integration users before computing representative-level aggregations.

Integration users may be retained for healthcare professional metrics while being excluded from representative metrics. The retention of integration users for healthcare professional metrics may be based on the assumption that integration users load actual interactions that occurred with healthcare professionals, even though the interactions were recorded through automated or bulk processes rather than individual representative data entry. The interactions loaded by integration users may represent genuine engagements with healthcare professionals that should be counted in healthcare professional-level metrics. However, including integration users in representative metrics may skew the metrics by including activity volumes that do not represent typical representative behavior.

Matrix engine controller 166 may also detect co-promote users as a special type of integration user. Co-promote arrangements may involve one organization contracting or partnering with another organization to co-promote a product. In co-promote arrangements, one organization may record interactions in its customer relationship management system and share the interaction data with the partner organization. The partner organization may load the shared interaction data into its own customer relationship management system, resulting in the same interactions being recorded in multiple customer relationship management systems.

Co-promote users may be identified based on username patterns that indicate the user is associated with a different organization than the customer relationship management system owner. A username containing a company name that differs from the organization operating the customer relationship management system may indicate a co-promote user. Co-promote users may also be identified based on data loading patterns that suggest bulk import of interaction data from an external source.

Interaction records associated with co-promote users may be excluded from both healthcare professional metrics and representative metrics to prevent double counting. If a single interaction is recorded in multiple customer relationship management systems due to co-promote data sharing, counting the interaction in each customer relationship management system would inflate the aggregated metrics. By excluding co-promote users, the system may count each interaction once based on the customer relationship management system where the interaction was originally recorded.

The integration user detection algorithm may also identify users who log interactions across multiple countries as a potential indicator of integration user status. Organizations may operate centers of excellence where customer relationship management administrators perform operations across multiple geographic regions. A user who records interactions with healthcare professionals in many different countries may be flagged for review based on the geographic distribution of the user's activity. Human representatives typically operate within a defined geographic territory and would not be expected to record interactions across numerous countries.

At 507, matrix engine controller 166 may freeze data to ensure the integrity and repeatability of the aggregated data and computed metrics. In one implementation, specialty changes may be locked at quarter freeze time so that historical data maintains original specialty classification. When the system freezes data at the end of a quarterly processing period, the specialty designations associated with each healthcare professional may be captured and preserved as part of the frozen data set. If a healthcare professional's specialty designation changes in the master data management system after the quarter freeze, the change may be reflected in subsequent quarterly data sets but may not affect previously frozen data sets. The locking of specialty information at quarter freeze time may ensure that organizations downloading historical data receive consistent specialty classifications that match the classifications used when the data was originally generated.

The preservation of original specialty classification in historical data may enable accurate comparison of engagement patterns across different time periods. If specialty classifications were updated retroactively in historical data sets, the changes could affect segment group composition and aggregated metrics in ways that would complicate longitudinal analysis. By maintaining original specialty classifications in frozen data sets, the system may provide stable historical data that supports consistent comparative analysis over time.

In some implementations, matrix engine controller 166 may freeze the interaction records and the computed aggregated channel metrics at predetermined quarterly intervals to preserve data integrity for comparative analysis across different time periods. The freezing operation may capture a snapshot of the interaction data and computed metrics at a defined point in time, creating a stable data set that remains unchanged for subsequent access and analysis. The predetermined quarterly intervals may align with calendar quarters, with the freezing operation occurring approximately two weeks after the end of each quarter to allow sufficient time for final data collection and processing before the data set is locked.

The two-week delay between quarter end and data freezing may provide a buffer period during which late-arriving interaction records can be incorporated into the quarterly data set. Interaction records may be submitted to customer relationship management systems with some delay after the actual engagement occurs, and the two-week buffer may capture these delayed submissions before the data set is frozen. The buffer period may also allow time for data quality checks and corrections to be applied before the quarterly data set is finalized and locked for distribution.

At 509, matrix engine controller 166 may segment the healthcare professionals into segment groups based on at least one of geographic region and medical specialty. The segmentation process may organize healthcare professionals into distinct groups that share common geographic or specialty characteristics, enabling aggregation and analysis of engagement patterns within each segment group. The segment groups may serve as the basis for subsequent processing operations including composite engagement score computation and data structure generation.

The segmentation based on geographic region may utilize country-level classification to organize healthcare professionals according to the country in which the healthcare professional practices. The system may support nineteen countries initially selected for availability of reference data in the master data management system. The nineteen countries may represent geographic regions where sufficient reference data coverage exists to support entity resolution and healthcare professional classification. Additional countries may be added to the system as reference data coverage expands to additional geographic regions.

The segmentation based on medical specialty may utilize specialty designations from a common data architecture to organize healthcare professionals according to the medical specialty in which the healthcare professional practices. The system may support sixty-seven common data architecture specialties for healthcare professional classification. The sixty-seven specialties may represent a comprehensive set of medical specialty designations that span primary care, internal medicine subspecialties, surgical specialties, and other areas of medical practice. The common data architecture may provide standardized specialty codes that enable consistent specialty classification across different geographic regions and data sources.

The master data management system may serve as the source for country and specialty information used during segmentation. The common data architecture maintained in the master data management system may define the standardized country codes and specialty codes applied during healthcare professional classification. By utilizing the master data management system as the authoritative source for country and specialty information, the system may ensure consistent classification across healthcare professionals matched from different customer relationship management systems.

Healthcare professional metrics may utilize the healthcare professional country from the master data management system. The healthcare professional country value stored in the master data management system may reflect the country where the healthcare professional is licensed to practice or where the healthcare professional maintains a primary practice location. By utilizing the healthcare professional country from the master data management system rather than country values stored in customer relationship management systems, the system may provide consistent geographic attribution for healthcare professional metrics across interaction records from multiple organizations.

Representative metrics may utilize the user country from the customer relationship management system. The user country value stored in the customer relationship management system may reflect the geographic territory assigned to the representative or the country where the representative is based. The differentiation between healthcare professional country source and representative country source may account for scenarios where a representative based in one country engages with healthcare professionals located in a different country. Healthcare professional metrics may be attributed to the healthcare professional's country of practice while representative metrics may be attributed to the representative's assigned country.

The segmentation process may retrieve specialty information from the master data management system for each healthcare professional included in the processing universe. The specialty information may include a primary specialty designation and a list of all specialty designations associated with the healthcare professional. The primary specialty designation may be used for segment group assignment during the segmentation process. The list of all specialty designations may be retained in output data to enable organizations to filter or analyze healthcare professionals based on any specialty in which the healthcare professional practices.

At 511, matrix engine controller 166 may compute composite engagement scores for each segment group.

In some implementations, matrix engine controller 166 may compute a composite engagement score for each healthcare professional within each segment group by applying weighted values to the engagement data for each of the plurality of communication channels. The composite engagement score may represent a numerical value that characterizes the overall engagement level associated with each healthcare professional based on the interaction records received from the plurality of customer relationship management systems. The composite engagement score may combine engagement data from multiple communication channels into a single value that enables comparison and ranking of healthcare professionals within each segment group.

The engagement data for each of the plurality of communication channels may include counts or measures of activities conducted through each channel during a defined time period. The plurality of communication channels may include video calls, non-video calls, sent electronic messages, and opened electronic messages, as described previously. The engagement data may be extracted from the interaction records received from the customer relationship management systems and may be aggregated at the healthcare professional level before application of weighted values.

In another implementation, the engagement data for each of the plurality of communication channels may also include events data. The interaction records received from the plurality of customer relationship management systems may also include events data documenting field-initiated engagements beyond individual representative interactions. The events data may encompass multiple field-initiated event types including speaker programs, advisory boards, roundtables, and other fee-for-service engagements conducted by organizations with healthcare professionals. Speaker programs may include educational presentations, peer-to-peer discussions, and promotional events where healthcare professionals present information about therapeutic products to other healthcare professionals. Advisory boards may include meetings where organizations convene groups of healthcare professionals to provide guidance on product development, clinical trial design, or commercial strategy. Roundtables may include smaller group discussions focused on specific therapeutic areas, treatment protocols, or emerging clinical evidence. Fee-for-service engagements may include consulting arrangements, market research participation, and other compensated activities involving healthcare professionals. The events data may include attendance tracking information indicating which healthcare professionals attended each event, enabling aggregation of event participation across multiple organizations. The events data may further include event classification attributes such as event type, event size indicating the number of attendees, and promotional status indicating whether the event included promotional content. The system may categorize promotional events by industry segment, event type, and event size to enable comparative analysis of event-based engagement patterns. The events data may be integrated with the engagement data from other communication channels when computing the composite engagement score for each healthcare professional, with weighted values applied to event attendance activities in addition to video calls, non-video calls, sent electronic messages, and opened electronic messages. The inclusion of events data in the anonymized structured data matrix may enable organizations to compare event-based engagement patterns against industry benchmarks while maintaining the same privacy protections applied to other communication channels.

Computing the composite engagement score may comprise applying a first weight to video call activities. The first weight may be a numerical coefficient that is multiplied by the count or measure of video call activities associated with each healthcare professional. The first weight may reflect the relative contribution of video call activities to the overall engagement characterization. Video call activities may represent synchronous remote engagements conducted through video conferencing channels where representatives and healthcare professionals interact in real-time with visual communication.

Computing the composite engagement score may comprise applying a second weight to non-video call activities. The second weight may be a numerical coefficient that is multiplied by the count or measure of non-video call activities associated with each healthcare professional. The second weight may reflect the relative contribution of non-video call activities to the overall engagement characterization. Non-video call activities may represent in-person visits, telephone calls, or other call-type engagements conducted through channels that do not involve video communication.

Computing the composite engagement score may comprise applying a third weight to sent electronic message activities. The third weight may be a numerical coefficient that is multiplied by the count or measure of sent electronic message activities associated with each healthcare professional. The third weight may reflect the relative contribution of sent electronic message activities to the overall engagement characterization. Sent electronic message activities may represent electronic mail communications transmitted from representatives to healthcare professionals through approved messaging channels.

Computing the composite engagement score may comprise applying a fourth weight to opened electronic message activities. The fourth weight may be a numerical coefficient that is multiplied by the count or measure of opened electronic message activities associated with each healthcare professional. The fourth weight may reflect the relative contribution of opened electronic message activities to the overall engagement characterization. Opened electronic message activities may represent instances where healthcare professionals opened electronic messages that were previously sent by representatives, indicating engagement with the message content.

The weighted values applied to each communication channel may be configured based on analytical objectives and engagement characterization requirements. The first weight, second weight, third weight, and fourth weight may be set to equal values when all communication channels are to contribute equally to the composite engagement score. In some cases, the weighted values may be set to different values to emphasize certain communication channels over others based on the relative significance of each channel type for engagement characterization purposes.

The computation of the composite engagement score may be performed by multiplying the engagement data for each communication channel by the corresponding weight and summing the weighted values across all communication channels. The resulting sum may represent the composite engagement score for the healthcare professional. The composite engagement score computation may be expressed as a weighted sum where the first weight is applied to video call activity counts, the second weight is applied to non-video call activity counts, the third weight is applied to sent electronic message counts, and the fourth weight is applied to opened electronic message counts.

The composite engagement score may be computed for each healthcare professional within each segment group. As described previously, the segment groups may be defined based on geographic region and medical specialty. The computation of composite engagement scores within each segment group may enable comparison of healthcare professionals who share common geographic or specialty characteristics. Healthcare professionals within the same segment group may be ranked or sorted based on their composite engagement scores to facilitate subsequent grouping operations.

The weighted values may be stored as configuration parameters that can be adjusted without modifying the underlying computation logic. The configuration parameters may be maintained in a configuration data store accessible to the one or more processors during composite engagement score computation. Changes to the weighted values may affect the composite engagement scores computed for healthcare professionals and may consequently affect the composition of data structures generated through subsequent grouping operations.

At 513, matrix engine controller 166 may sort the healthcare professionals within each segment group based on the composite engagement scores. The sorting operation may arrange healthcare professionals in a ranked order according to their computed composite engagement scores, enabling subsequent grouping operations to identify healthcare professionals with similar engagement levels. The sorting may be performed in descending order such that healthcare professionals with higher composite engagement scores are positioned before healthcare professionals with lower composite engagement scores within each segment group. In some cases, the sorting may be performed in ascending order based on processing requirements or analytical objectives.

The sorting operation may be performed separately for each segment group defined by geographic region and medical specialty, as described previously. By sorting healthcare professionals within each segment group independently, the system may ensure that subsequent grouping operations create data structures containing healthcare professionals who share common geographic and specialty characteristics in addition to similar engagement levels. The sorted order within each segment group may serve as the basis for sequential grouping of healthcare professionals into data structures.

Following the sorting operation, matrix engine controller 166 may generate a plurality of data structures. In one implementation, healthcare professionals may be sorted into data structures, or matrices, each comprising a fixed number of healthcare professionals having associated composite engagement scores. The grouping operation may traverse the sorted list of healthcare professionals within each segment group and assign consecutive healthcare professionals to data structures based on the fixed number parameter. The data structures may serve as aggregation units for computing channel metrics that obscure individual healthcare professional engagement patterns while preserving analytical value for comparative purposes.

The fixed number of healthcare professionals in each data structure may be five. The selection of five healthcare professionals as the fixed number may provide a balance between aggregation granularity and privacy protection. A data structure containing five healthcare professionals may aggregate sufficient engagement data to compute meaningful average metrics while preventing identification of individual healthcare professional engagement patterns from the aggregated values. The fixed number of five may be applied consistently across all data structures generated within each segment group and across all segment groups processed by the system.

The fixed number may be selected to prevent identification of individual healthcare professional engagement patterns. By aggregating engagement data across multiple healthcare professionals within each data structure, the system may obscure the specific engagement values associated with any individual healthcare professional. The aggregated metrics computed for each data structure may represent average values across the fixed number of healthcare professionals, making it difficult to determine the engagement pattern of any single healthcare professional from the aggregated output. The selection of the fixed number may consider privacy requirements, analytical utility, and the minimum aggregation level sufficient to prevent reverse engineering of individual engagement data.

At 517, matrix engine controller 166 determines whether each data structure satisfies a threshold proximity such that healthcare professionals within each data structure have composite engagement scores that differ by less than a predetermined variance value. The threshold proximity constraint may ensure that healthcare professionals grouped together in a data structure have similar overall engagement levels as characterized by their composite engagement scores. By grouping healthcare professionals with similar composite engagement scores, the system may create data structures where the aggregated metrics are representative of the engagement patterns shared by the healthcare professionals within the data structure.

The predetermined variance value may define the maximum allowable difference between the highest and lowest composite engagement scores among healthcare professionals within a single data structure. The predetermined variance value may be configured based on the distribution of composite engagement scores within each segment group and the desired homogeneity of engagement levels within each data structure. A smaller predetermined variance value may result in data structures containing healthcare professionals with more similar engagement levels, while a larger predetermined variance value may allow greater variation in engagement levels within each data structure. In one implementation, matrix engine controller 166 may display or indicate whether a data structure satisfies the threshold proximity.

At 519, matrix engine controller 166 code each data structure. In one implementation, each data structure generated through the grouping operation may be assigned a matrix identifier that uniquely identifies the data structure within the system. The matrix identifier may follow a non-sequential, random digit naming convention that specifies the country, specialty, and year followed by seven random digits for uniqueness. The matrix identifier format may use the convention of current use year, quarter, two-digit ISO country code, primary common data architecture specialty code, and seven random digits concatenated together. An example matrix identifier may be formatted as 2025_q2_us_im_3949320, where 2025 represents the year, q2 represents the quarter, us represents the two-digit ISO country code for the United States, im represents the common data architecture specialty code for internal medicine, and 3949320 represents seven random digits generated for uniqueness.

The non-sequential, random digit naming convention for matrix identifiers may prevent inference of data structure characteristics from the identifier value. By including random digits rather than sequential numbering, the matrix identifier may not reveal the relative position or ranking of the data structure within the segment group. The inclusion of country, specialty, and year components in the matrix identifier may enable efficient filtering and retrieval of data structures based on geographic and specialty criteria while maintaining uniqueness through the random digit suffix.

The matrix identifier may be generated during the matrix building process when healthcare professionals are grouped into data structures. The random digit component of the matrix identifier may be generated using a random number generator or pseudo-random number generator that produces seven-digit values. The generated matrix identifier may be stored in association with the data structure and may be included in output files that associate healthcare professional identifiers with their corresponding data structures.

In some implementations, matrix engine controller 166 may generate scrambled customer identifiers for each organization by applying a hash function to an anonymized customer identifier. The scrambled customer identifiers may be generated to maintain organization anonymity in output files that contain organization-specific metrics or data. The generation of scrambled customer identifiers may transform the anonymized customer identifier associated with each organization into a derived identifier that does not reveal the original customer identifier value while still enabling consistent identification of organization-specific data across multiple output files and time periods.

The hash function applied to the anonymized customer identifier may be a SHA-256 hash function. The SHA-256 hash function may produce a 256-bit hash value from the input anonymized customer identifier. The SHA-256 hash function may be a cryptographic hash function that generates a deterministic output for a given input, such that the same anonymized customer identifier produces the same hash value each time the hash function is applied. The deterministic property of the SHA-256 hash function may enable consistent generation of scrambled customer identifiers across different processing cycles and output file generations.

The scrambled customer identifier may be generated using a formula that concatenates a prefix with a substring of the SHA-256 hash value. The formula for generating the scrambled customer identifier may be expressed as CONCAT(‘cid\_’, SUBSTRING(SHA2({anon\_customer\_id\_\_v}, 256), 1, 16)). The formula may apply the SHA-256 hash function to the anonymized customer identifier value, extract the first sixteen characters of the resulting hash value, and concatenate the extracted substring with a prefix of ‘cid\_’ to produce the scrambled customer identifier. An example scrambled customer identifier generated using this formula may be cid\_5ae53c0c85e14b20, where ‘cid\_’ represents the prefix and ‘5ae53c0c85e14b20’ represents the first sixteen characters of the SHA-256 hash of the anonymized customer identifier.

The extraction of the first sixteen characters from the SHA-256 hash value may produce a scrambled customer identifier of sufficient length to provide uniqueness across organizations while maintaining a compact identifier format suitable for inclusion in file names and data records. The sixteen-character substring may provide a large identifier space that reduces the probability of identifier collisions between different organizations. The prefix ‘cid\_’ may indicate that the identifier represents a customer identifier, enabling identification of the identifier type within output files and file names.

The scrambled customer identifiers may be included in output files to maintain organization anonymity. The inclusion of scrambled customer identifiers in output files may enable organizations to identify their own data within the output files while preventing other organizations from determining the identity of the organization associated with a particular scrambled customer identifier. The scrambled customer identifier may replace the original customer identifier or organization name in output files, ensuring that the output files do not contain information that directly identifies the organization.

File output names for customer-specific files may contain the product, year, quarter, country, metric name, and scrambled customer identifier. The file naming convention for customer-specific files may follow the format pulse\_{yyyy}{quarter}{country}{metricname} {scrambledcustomerid}, where {yyyy} represents the four-digit year, {quarter} represents the quarter identifier, {country} represents the country code, {metricname} represents the name of the metric file, and {scrambledcustomerid} represents the scrambled customer identifier generated using the hash function formula described above. An example file name following this convention may be pulse\_2025\_q1\_us\_hcpcompanymetrics\_cid\_5ae53c0c85e14b20, where pulse represents the product name, 2025 represents the year, q1 represents the first quarter, us represents the United States country code, hcpcompanymetrics represents the metric file name, and cid\_5ae53c0c85e14b20 represents the scrambled customer identifier.

The inclusion of the scrambled customer identifier in the file name may enable the system to generate and store customer-specific output files without revealing the organization identity in the file system or during file distribution. The scrambled customer identifier in the file name may enable organizations to identify their own files when accessing the data distribution system while preventing other organizations from associating the files with a particular organization. The file naming convention may provide a consistent and predictable format that enables automated processing and retrieval of customer-specific output files.

The scrambled customer identifiers may also be included within the data records contained in customer-specific output files. The data records may include a field containing the scrambled customer identifier to enable identification of the organization associated with each record. The inclusion of the scrambled customer identifier within data records may enable organizations to filter and process records associated with their organization when working with combined data sets that may contain records from multiple organizations.

The generation of scrambled customer identifiers may be performed during the output file generation process when customer-specific metric files are created. The system may retrieve the anonymized customer identifier associated with each organization, apply the SHA-256 hash function to the anonymized customer identifier, extract the first sixteen characters of the hash value, concatenate the prefix, and include the resulting scrambled customer identifier in the output file name and data records. The scrambled customer identifier generation may be performed consistently across all customer-specific output files to ensure that the same organization receives the same scrambled customer identifier in all output files.

At 521, matrix engine controller 166 generates anonymized secure data matrices for various levels.

In one implementation, the grouping operation may handle segment groups where the total number of healthcare professionals is not evenly divisible by the fixed number of five. When the number of healthcare professionals in a segment group is not a multiple of five, the final data structure in the segment group may contain fewer than five healthcare professionals, or the remaining healthcare professionals may be distributed across existing data structures according to configured handling rules. In some cases, healthcare professionals who cannot be grouped into a complete data structure of five may be excluded from data structure assignment for the current processing period.

The data structures generated through the grouping operation may serve as the basis for subsequent metric computation and output generation. Each data structure may contain references to the five healthcare professionals assigned to the data structure, enabling retrieval of interaction records associated with those healthcare professionals for aggregated metric computation. The data structure may also store the matrix identifier, segment group attributes including country and specialty, and metadata indicating the time period for which the data structure was generated.

In some implementations, the one or more processors may compute aggregated channel metrics for each data structure. The aggregated channel metrics may characterize the engagement patterns associated with the healthcare professionals grouped within each data structure by summarizing interaction data across the plurality of communication channels. The computation of aggregated channel metrics may transform individual healthcare professional engagement data into aggregated values that obscure individual engagement patterns while preserving analytical utility for comparative purposes.

The aggregated channel metrics may comprise an average engagement value for each of the plurality of communication channels calculated across the healthcare professionals within the data structure. The average engagement value for each communication channel may be computed by summing the engagement data for that channel across all healthcare professionals within the data structure and dividing by the number of healthcare professionals in the data structure. The resulting average values may represent typical engagement levels for healthcare professionals grouped within the data structure, enabling organizations to understand engagement patterns without accessing individual healthcare professional engagement data.

The computation of aggregated channel metrics may include computing a matrix average non-video calls metric. The matrix average non-video calls metric may be computed by summing the number of non-video calls across all healthcare professionals within the data structure and dividing by the number of healthcare professionals in the data structure. The formula for the matrix average non-video calls metric may be expressed as the sum of non-video calls divided by the number of healthcare professionals. For a data structure containing five healthcare professionals, the matrix average non-video calls metric may represent the mean number of non-video call interactions received by healthcare professionals within that data structure during the measurement period.

The computation of aggregated channel metrics may include computing a matrix average video calls metric. The matrix average video calls metric may be computed by summing the number of video calls across all healthcare professionals within the data structure and dividing by the number of healthcare professionals in the data structure. The formula for the matrix average video calls metric may be expressed as the sum of video calls divided by the number of healthcare professionals. The matrix average video calls metric may characterize the level of video-based engagement experienced by healthcare professionals grouped within the data structure.

The computation of aggregated channel metrics may include computing a matrix average sent emails metric. The matrix average sent emails metric may be computed by summing the number of sent electronic messages across all healthcare professionals within the data structure and dividing by the number of healthcare professionals in the data structure. The formula for the matrix average sent emails metric may be expressed as the sum of sent emails divided by the number of healthcare professionals. The matrix average sent emails metric may indicate the volume of electronic message communications directed to healthcare professionals within the data structure.

The computation of aggregated channel metrics may include computing a matrix average opened emails metric. The matrix average opened emails metric may be computed by summing the number of opened electronic messages across all healthcare professionals within the data structure and dividing by the number of healthcare professionals in the data structure. The formula for the matrix average opened emails metric may be expressed as the sum of opened emails divided by the number of healthcare professionals. The matrix average opened emails metric may characterize healthcare professional engagement with electronic message content by measuring the average number of messages opened by healthcare professionals within the data structure.

The computation of aggregated channel metrics may include computing a matrix average access metric. The matrix average access metric may represent the average number of distinct companies or organizations that interact with healthcare professionals within the data structure. The matrix average access metric may be computed by summing the number of companies interacting with each healthcare professional and dividing by the number of healthcare professionals in the data structure. The formula for the matrix average access metric may be expressed as the sum of companies interacting with healthcare professionals divided by the number of healthcare professionals. The matrix average access metric may indicate the breadth of industry engagement experienced by healthcare professionals grouped within the data structure.

The aggregated channel metrics may be calculated at the healthcare professional level before being divided by the number of healthcare professionals in the data structure to produce matrix averages. For each healthcare professional within the data structure, the system may compute the distinct count of companies that engaged with that healthcare professional during the measurement period. The distinct count values may be summed across all healthcare professionals within the data structure and divided by the number of healthcare professionals to produce the matrix average access metric. The approach of computing metrics at the healthcare professional level before aggregation may enable counting of total access versus total unique access within the data structure.

The aggregated channel metrics computed for each data structure may be stored in association with the matrix identifier assigned to the data structure. The stored aggregated channel metrics may include the matrix average non-video calls, matrix average video calls, matrix average sent emails, matrix average opened emails, and matrix average access values computed for the data structure. The stored metrics may be retrieved during output generation to populate metric files that associate healthcare professional identifiers with their corresponding data structure metrics.

In some implementations, matrix engine controller 166 may determine whether a data structure exceeds a customer concentration threshold indicating that engagement activity from a single organization exceeds a predetermined percentage of total engagement activity within the data structure. The customer concentration threshold may be evaluated for each data structure generated through the grouping operation to assess whether the distribution of engagement activity across organizations meets criteria for sharing aggregated metrics. The determination may involve analyzing the interaction records associated with healthcare professionals within the data structure to identify the organization that contributed each interaction record and to compute the proportion of total engagement activity attributable to each organization.

The predetermined percentage may be set to sixty percent of total engagement activity within the data structure. When a single organization accounts for more than sixty percent of the engagement activities recorded for healthcare professionals within a data structure, the data structure may be considered to exceed the customer concentration threshold. The sixty percent threshold may be selected to ensure that aggregated metrics reflect engagement patterns from multiple organizations rather than being dominated by the activity of a single organization. The predetermined percentage may be configured as a system parameter that can be adjusted based on privacy requirements and analytical objectives.

The one or more processors may block access to the aggregated channel metrics for the data structure in response to determining that the customer concentration threshold is exceeded. When a data structure exceeds the customer concentration threshold, the system may prevent organizations from accessing the aggregated channel metrics computed for that data structure. The blocking of access may protect the anonymity of organizations by preventing scenarios where aggregated metrics could reveal proprietary engagement strategies of a single dominant organization within the data structure.

In some implementations, the one or more processors may determine whether a data structure has interaction records from fewer than a minimum number of organizations. The minimum number of organizations may be set to three customers represented within the data structure. The determination may involve counting the distinct organizations that contributed interaction records associated with healthcare professionals within the data structure. When the count of distinct organizations is less than the minimum number of three, the data structure may be considered to have insufficient organizational diversity for sharing aggregated metrics.

The one or more processors may block access to the aggregated channel metrics for the data structure in response to determining that the data structure has interaction records from fewer than the minimum number of organizations. When a data structure has interaction records from fewer than three organizations, the system may prevent organizations from accessing the aggregated channel metrics computed for that data structure. The blocking of access based on the minimum organization count may complement the customer concentration threshold by ensuring that aggregated metrics reflect engagement patterns from a sufficient number of organizations to prevent identification of individual organizational activity.

Data structures that are blocked due to exceeding the customer concentration threshold or having fewer than the minimum number of organizations may have metrics zeroed out and a blocked field set to indicate the blocked status. The blocked field may be set to a value of yes or a character value of y to indicate that the data structure is blocked. The aggregated channel metrics for blocked data structures may be published as zero values rather than the computed average values. The combination of zeroed metrics and the blocked indicator may enable organizations to identify blocked data structures while preventing access to aggregated metrics that could compromise organizational anonymity.

Matrix metrics may be blocked and published as zero with a blocked value of y when industry participation is too low or too concentrated to share. The blocking mechanism may be applied when the customer concentration threshold is exceeded or when the minimum organization count is not met. The blocked data structures may still appear in output files with the matrix identifier and healthcare professional associations, but the aggregated channel metrics may be replaced with zero values and the blocked field may indicate the blocked status.

Approximately two to three percent of matrices may be blocked in the United States due to low activity resulting in high customer concentration. The percentage of blocked matrices may vary across different geographic regions and specialty segments based on the distribution of engagement activity across organizations. The blocking may occur more frequently on the lower engagement side of the engagement spectrum, where data structures containing healthcare professionals with lower composite engagement scores may have fewer total interactions and consequently higher susceptibility to customer concentration issues. When engagement activity is low within a data structure, a smaller number of interactions from a single organization may exceed the sixty percent threshold, resulting in blocking of the data structure.

The blocking mechanism may protect organizational anonymity by preventing scenarios where aggregated metrics could be reverse engineered to identify the engagement strategies of individual organizations. By requiring at least three organizations to be represented within each data structure and limiting any single organization to no more than sixty percent of total engagement activity, the system may ensure that aggregated metrics reflect industry-wide engagement patterns rather than the activity of individual organizations. The blocking of non-compliant data structures may preserve the integrity of the anonymization approach while still providing analytical value for data structures that meet the compliance criteria.

In some implementations, matrix engine controller 166 may generate an anonymized structured data matrix associating each healthcare professional identifier with the aggregated channel metrics of the corresponding data structure in place of individual engagement values for the healthcare professional. The anonymized structured data matrix may serve as the output data structure that organizations access to obtain comparative engagement information without exposure to individual healthcare professional engagement data or proprietary organizational engagement strategies. The generation of the anonymized structured data matrix may transform the relationship between healthcare professional identifiers and engagement data by replacing individual engagement values with aggregated metrics computed at the data structure level.

The anonymized structured data matrix may comprise rows corresponding to healthcare professionals included in the processing universe and columns corresponding to data attributes including the healthcare professional identifier, data structure identifier, and aggregated channel metrics. For each healthcare professional, the anonymized structured data matrix may store the globally unique identifier that enables identification of the healthcare professional, the matrix identifier of the data structure to which the healthcare professional was assigned during the grouping operation, and the aggregated channel metrics computed for that data structure. The aggregated channel metrics stored in the anonymized structured data matrix may include the matrix average non-video calls, matrix average video calls, matrix average sent emails, matrix average opened emails, and matrix average access values, as described previously.

The association of each healthcare professional identifier with the aggregated channel metrics of the corresponding data structure may replace the individual engagement values that would otherwise characterize the healthcare professional's engagement pattern. Rather than storing the specific number of non-video calls, video calls, sent emails, and opened emails received by each individual healthcare professional, the anonymized structured data matrix may store the average values computed across all healthcare professionals within the data structure to which the healthcare professional was assigned. The replacement of individual engagement values with aggregated channel metrics may obscure the specific engagement pattern of any single healthcare professional while preserving information about the general engagement level associated with healthcare professionals grouped within the same data structure.

The generation of the anonymized structured data matrix may prevent exposure of individual healthcare professional engagement data by ensuring that the output data does not contain values that directly characterize the engagement pattern of any single healthcare professional. When an organization accesses the anonymized structured data matrix, the organization may observe that a particular healthcare professional is associated with a data structure having certain average engagement values, but the organization may not determine the specific engagement values attributable to that individual healthcare professional. The aggregated channel metrics may represent the combined engagement patterns of five healthcare professionals within the data structure, making it difficult to isolate the contribution of any single healthcare professional to the aggregated values.

The generation of the anonymized structured data matrix may prevent exposure of proprietary organizational engagement strategies by aggregating engagement data across multiple organizations before computing the channel metrics. The aggregated channel metrics stored in the anonymized structured data matrix may reflect engagement activity from multiple organizations that interact with healthcare professionals within each data structure. Because the aggregated metrics combine engagement data from multiple organizations, the metrics may not reveal the specific engagement strategies, targeting approaches, or activity volumes of any individual organization. The customer concentration threshold and minimum organization count requirements, as described previously, may further protect organizational anonymity by blocking data structures where aggregated metrics could be dominated by or attributable to a single organization.

The anonymized structured data matrix may enable comparative analysis of engagement patterns by providing organizations with information about the relative engagement levels associated with different healthcare professionals. An organization may compare the aggregated channel metrics associated with healthcare professionals in the organization's customer relationship management system against the aggregated channel metrics associated with healthcare professionals in other data structures to identify engagement opportunities or gaps. The comparative analysis may be conducted without the organization accessing individual engagement values for healthcare professionals or learning the specific engagement strategies employed by other organizations.

The generation of the anonymized structured data matrix may involve populating output data files with the healthcare professional identifiers and corresponding aggregated channel metrics retrieved from the data structures generated during the grouping operation. The output data files may be formatted as comma-separated value files or other structured data formats suitable for import into analytical systems operated by organizations. The output data files may include header rows that identify the data attributes contained in each column, enabling organizations to parse and process the anonymized structured data matrix using standard data processing tools.

The anonymized structured data matrix may include additional data attributes beyond the healthcare professional identifier and aggregated channel metrics. The additional data attributes may include the time period for which the metrics were computed, the year and quarter identifiers, the country code, the primary specialty code and label, the list of all specialty codes and labels associated with the healthcare professional, and the blocked indicator for data structures that do not meet compliance criteria. The additional data attributes may enable organizations to filter, segment, and analyze the anonymized structured data matrix based on temporal, geographic, and specialty dimensions.

The generation of the anonymized structured data matrix may be performed as part of a quarterly processing cycle that produces output data files for distribution to organizations. The quarterly processing cycle may freeze interaction data and reference data at a defined point in time, compute aggregated channel metrics based on the frozen data, generate the anonymized structured data matrix, and package the output data files for distribution. The quarterly cadence may provide organizations with regular updates to engagement pattern information while allowing sufficient time for data accumulation and processing between distribution cycles.

In some implementations, matrix engine controller 166 may store the anonymized structured data matrix in a non-transitory computer-readable storage medium for access by the organizations to enable comparative analysis of engagement patterns without exposing individual healthcare professional engagement data or proprietary organizational engagement strategies. The non-transitory computer-readable storage medium may include magnetic storage devices, solid-state storage devices, optical storage media, network-attached storage systems, or cloud-based storage services capable of persistently storing the anonymized structured data matrix. The storage of the anonymized structured data matrix may involve writing output data files to the non-transitory computer-readable storage medium in a format suitable for retrieval and distribution to authorized organizations.

The anonymized structured data matrix may be stored in a storage device for access by the organizations to enable comparative analysis of engagement patterns without exposing individual healthcare professional engagement data or proprietary organizational engagement strategies. The storage device may be configured with redundant storage mechanisms to ensure data durability and availability. The storage device may implement access controls that restrict retrieval of the anonymized structured data matrix to authorized users associated with organizations that have purchased access to the data.

In some implementations, matrix engine controller 166 may generate a plurality of metric files at different granularities comprising at least a data structure metrics file, a country metrics file, a specialty metrics file, and a company metrics file. The plurality of metric files may provide organizations with engagement pattern information at various levels of aggregation, enabling different types of comparative analysis based on the granularity of data required for particular analytical use cases. The generation of metric files at different granularities may support both broad industry-level benchmarking and detailed data structure-level analysis within a unified data distribution framework.

The system may generate eight metric files for each country and quarter combination, comprising six industry files and two company files. The six industry files may contain aggregated metrics computed across all organizations that contribute interaction data to the system, providing industry-wide benchmark values that any organization may access for comparative purposes. The two company files may contain organization-specific metrics computed using data from a single organization, enabling the organization to compare its own engagement performance against the industry benchmarks contained in the industry files.

Among the eight metric files, six files may be healthcare professional-focused and two files may be representative-focused. The six healthcare professional-focused files may contain metrics characterizing engagement patterns from the perspective of healthcare professionals who receive engagements from representatives across multiple organizations. The two representative-focused files may contain metrics characterizing engagement patterns from the perspective of representatives who conduct engagements with healthcare professionals on behalf of their respective organizations.

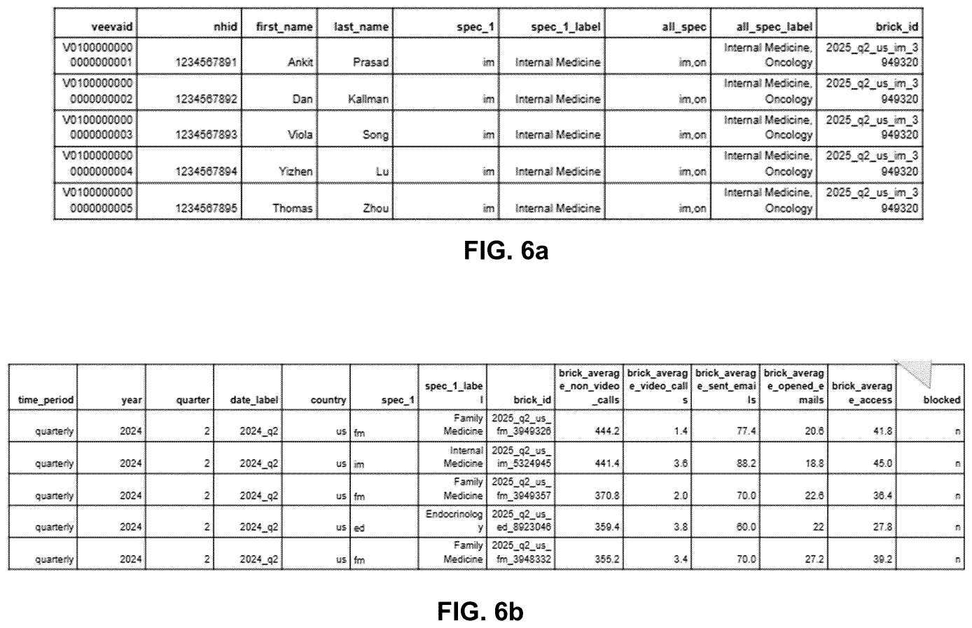

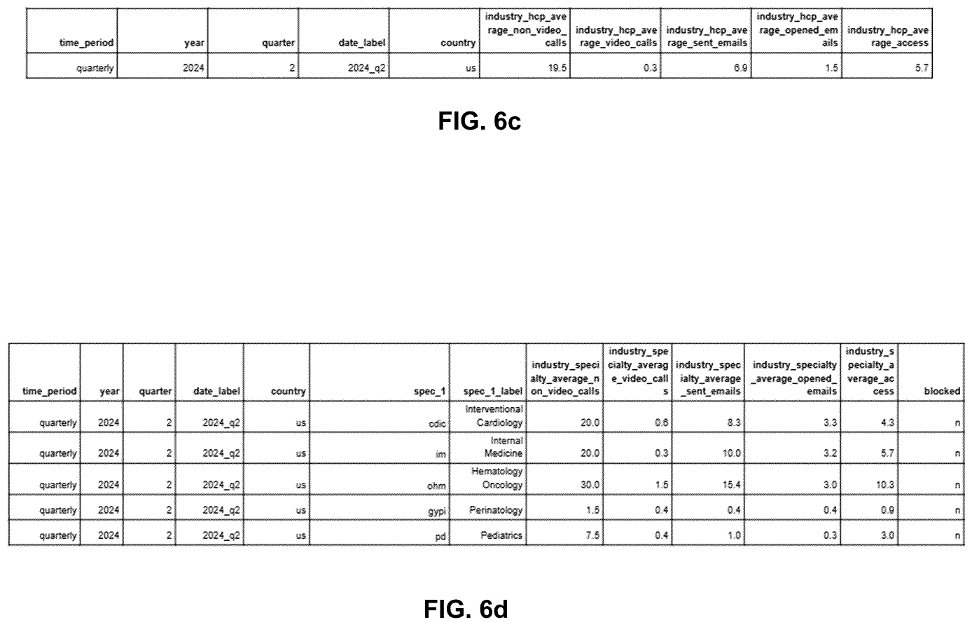

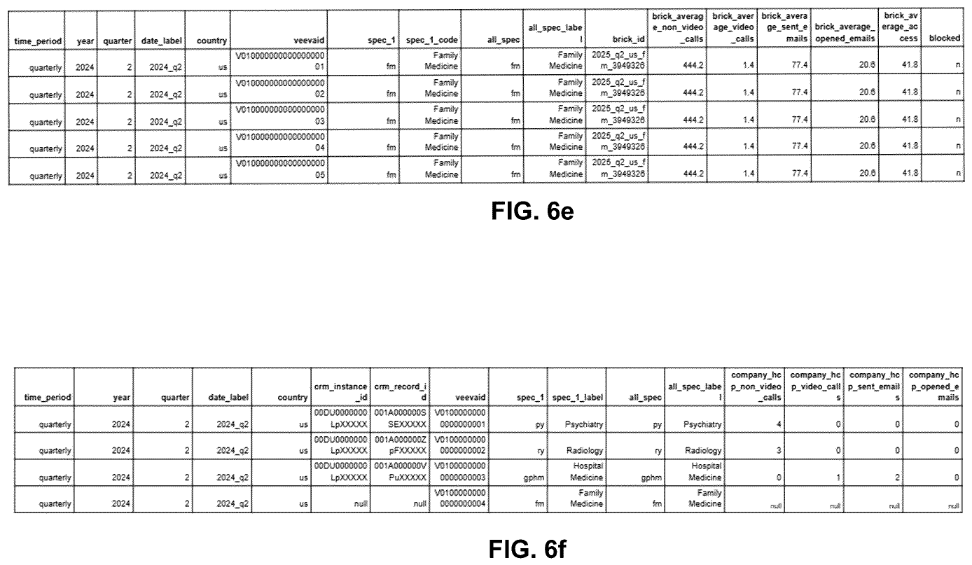

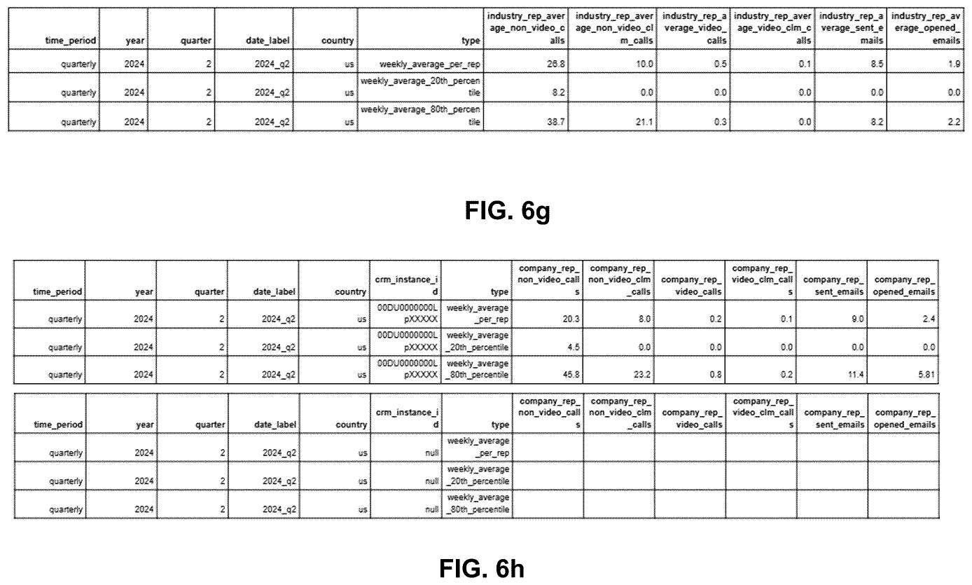

The multiple metric file types may include an hcptobrick file for mapping healthcare professionals to data structures as depicted in FIG. 6a. The hcptobrick file may contain records associating each healthcare professional identifier with the brick identifier of the data structure to which the healthcare professional was assigned during the grouping operation described previously. The hcptobrick file may include the globally unique identifier for each healthcare professional, a national health identifier where applicable, first name, last name, primary specialty code, primary specialty label, all specialty codes, all specialty labels, and the brick identifier. The hcptobrick file may enable organizations to identify which healthcare professionals had industry activity in the previous quarter and to determine the data structure assignment for each healthcare professional.

The multiple metric file types may include a brickmetrics file for aggregate healthcare professional metrics at the data structure level, as depicted in FIG. 6b. The brickmetrics file may serve as the data structure metrics file containing aggregated channel metrics computed for each data structure as described previously. The brickmetrics file may contain records for each data structure including the time period, year, quarter, date label, country, primary specialty code, primary specialty label, brick identifier, brick average non-video calls, brick average video calls, brick average sent emails, brick average opened emails, brick average access, and blocked indicator. The brickmetrics file may enable organizations to analyze engagement patterns at the data structure level and to identify data structures with high or low engagement activity.

The multiple metric file types may include an hcpcountrymetrics file for aggregate healthcare professional metrics at the country level, as depicted in FIG. 6c. The hcpcountrymetrics file may serve as the country metrics file containing industry-level metrics computed across all healthcare professionals within each country as described previously. The hcpcountrymetrics file may contain records including the time period, year, quarter, date label, country, industry healthcare professional average non-video calls, industry healthcare professional average video calls, industry healthcare professional average sent emails, industry healthcare professional average opened emails, and industry healthcare professional average access. The hcpcountrymetrics file may provide country-level benchmark values that organizations may use to assess overall industry engagement patterns within each geographic region.

The multiple metric file types may include an hcpspecialtymetrics file for aggregate healthcare professional metrics at the specialty level, as depicted in FIG. 6d. The hcpspecialtymetrics file may serve as the specialty metrics file containing industry-level metrics computed across all healthcare professionals within each medical specialty as described previously. The hcpspecialtymetrics file may contain records including the time period, year, quarter, date label, country, specialty code, specialty label, industry specialty average non-video calls, industry specialty average video calls, industry specialty average sent emails, industry specialty average opened emails, industry specialty average access, and blocked indicator. The hcpspecialtymetrics file may enable organizations to compare engagement patterns across different medical specialties and to identify specialties with above-average or below-average industry engagement activity.

The multiple metric file types may include an hcpbrickmetrics file for healthcare professionals with related data structure metrics inline, as depicted in FIG. 6e. The hcpbrickmetrics file may combine healthcare professional identification information with the aggregated channel metrics of the corresponding data structure in a single denormalized record format. The hcpbrickmetrics file may contain records including the time period, year, quarter, date label, country, globally unique identifier, primary specialty code, primary specialty label, all specialty codes, all specialty labels, brick identifier, brick average non-video calls, brick average video calls, brick average sent emails, brick average opened emails, brick average access, and blocked indicator. The hcpbrickmetrics file may enable organizations to analyze healthcare professional-level data with associated data structure metrics without requiring joins between separate files.

The multiple metric file types may include an hcpcompanymetrics file for company metrics for covered healthcare professionals, as depicted in FIG. 6f. The hcpcompanymetrics file may serve as the company metrics file containing organization-specific metrics computed for healthcare professionals engaged by a particular organization. The hcpcompanymetrics file may contain records including the time period, year, quarter, date label, country, customer relationship management instance identifier, customer relationship management record identifier, globally unique identifier, primary specialty code, primary specialty label, all specialty codes, all specialty labels, company healthcare professional non-video calls, company healthcare professional video calls, company healthcare professional sent emails, and company healthcare professional opened emails. The hcpcompanymetrics file may enable organizations to compare their own engagement metrics for individual healthcare professionals against the industry-level metrics contained in other metric files.

The multiple metric file types may include a repcountrymetrics file for representative metrics at the country level, as depicted in FIG. 6g. The repcountrymetrics file may contain industry-level metrics characterizing representative engagement activity computed across all representatives within each country. The repcountrymetrics file may contain records including the time period, year, quarter, date label, country, type indicator, industry representative average non-video calls, industry representative average non-video closed loop marketing calls, industry representative average video calls, industry representative average video closed loop marketing calls, industry representative average sent emails, and industry representative average opened emails. The type indicator may distinguish between weekly average per representative, weekly average twentieth percentile, and weekly average eightieth percentile metric types.

The multiple metric file types may include a repcompanymetrics file for company metrics at the country level, as depicted in FIG. 6h. The repcompanymetrics file may contain organization-specific metrics characterizing representative engagement activity for a particular organization. The repcompanymetrics file may contain records including the time period, year, quarter, date label, country, customer relationship management instance identifier, type indicator, company representative non-video calls, company representative non-video closed loop marketing calls, company representative video calls, company representative video closed loop marketing calls, company representative sent emails, and company representative opened emails. The repcompanymetrics file may enable organizations to compare their representative engagement metrics against the industry-level representative metrics contained in the repcountrymetrics file.

The system may pre-zip the eight metric files together for one-click download by organizations. The pre-zipping of metric files may package all metric files for a particular country and quarter into a single compressed archive file that organizations may download with a single action. The pre-zipped archive may reduce the number of download operations required for organizations to obtain a complete data set and may simplify the data retrieval process. The one-click download capability may enable organizations to access all metric files without selecting individual files or waiting for on-demand compression operations to complete.

File output names for non-customer specific files may contain the product, year, quarter, country, and metric name using the convention pulse\\_{yyyy}{quarter}{country}\\_{metricname}. The file naming convention may provide a consistent and predictable format that enables identification of file contents based on the file name. The {yyyy} component may represent the four-digit year, the {quarter} component may represent the quarter identifier such as q1 or q2, the {country} component may represent the two-character country code, and the {metricname} component may represent the name of the metric file type. An example file name following this convention may be pulse\\_2025\\_q1\\_us\\_hcptobrick, where pulse represents the product name, 2025 represents the year, q1 represents the first quarter, us represents the United States country code, and hcptobrick represents the metric file type for healthcare professional to data structure mapping.

In some implementations, matrix engine controller 166 may enable an organization to compare the organization's engagement metrics against the aggregated channel metrics to identify healthcare professionals in high-activity data structures that are not present in the organization's customer relationship management system. The comparison capability may allow organizations to leverage the anonymized structured data matrix and associated metric files to assess engagement opportunities and gaps relative to industry-wide engagement patterns. By comparing organization-specific engagement data against the aggregated channel metrics computed for data structures across the industry, organizations may identify healthcare professionals who receive high levels of industry engagement but who are not currently targeted or engaged by the organization.

The comparison process may involve joining multiple metric files to correlate organization-specific data with industry-level data structure metrics. An organization may join the hcpbrickmetrics file, the hcpcompanymetrics file, and the hcptobrick file on the globally unique identifier to create a combined data set that associates each healthcare professional with both the aggregated channel metrics of the corresponding data structure and the organization's own engagement metrics for that healthcare professional. The joined data set may enable the organization to analyze the relationship between industry engagement levels and the organization's engagement activity for each healthcare professional.

The identification of healthcare professionals in high-activity data structures that are not present in the organization's customer relationship management system may be performed by filtering the joined data set based on data structure engagement levels and organization engagement status. Healthcare professionals associated with data structures having high aggregated channel metrics may be identified as being in high-activity data structures, indicating that these healthcare professionals receive substantial engagement from the industry as a whole. Among the healthcare professionals in high-activity data structures, the organization may identify those healthcare professionals for whom the organization has no engagement records or for whom the organization's customer relationship management system contains no corresponding account record.

The comparison may reveal engagement gaps where healthcare professionals receive high levels of industry engagement but are not engaged by the organization. When a healthcare professional is associated with a data structure having high brick average values for non-video calls, video calls, sent emails, or opened emails, the healthcare professional may be considered to be in a high-activity data structure. If the organization's hcpcompanymetrics file contains null values or no record for that healthcare professional, the organization may determine that the healthcare professional is not present in the organization's customer relationship management system or has not been engaged by the organization during the measurement period. The identification of such healthcare professionals may inform organizational decisions regarding customer relationship management data acquisition, targeting strategy adjustments, and engagement resource allocation.

The various metrics files (e.g., FIG. 6a-h) may answer various business questions related to industry access, engagement patterns, and comparative performance analysis. The hcpbrickmetrics file may answer questions regarding the industry access by channel of a healthcare professional within an aggregated healthcare professional group. By examining the brick average values for each communication channel associated with a healthcare professional's data structure, an organization may understand the typical engagement levels experienced by healthcare professionals grouped with similar engagement profiles. The hcpbrickmetrics file may also answer questions regarding how many companies interact with a healthcare professional within an aggregated healthcare professional group, as the brick average access metric indicates the average number of distinct organizations engaging with healthcare professionals within each data structure.

The hcpspecialtymetrics file may answer questions regarding the industry access within a specific specialty. Organizations may examine the industry specialty average values for each communication channel to understand engagement patterns within particular medical specialty segments. The specialty-level metrics may enable organizations to compare engagement levels across different specialties and to identify specialties with above-average or below-average industry engagement activity.

The hcpcountrymetrics file may answer questions regarding the industry access within a country. Organizations may examine the industry healthcare professional average values for each communication channel to understand overall engagement patterns within each geographic region. The country-level metrics may provide benchmark values that organizations may use to assess whether their engagement levels are consistent with industry norms for particular countries.

The hcptobrick file may answer questions regarding which healthcare professionals had any industry activity in the previous quarter. By examining the healthcare professionals included in the hcptobrick file, organizations may identify healthcare professionals who received engagement from the industry during the measurement period. Healthcare professionals who appear in the hcptobrick file may be considered to have had industry activity, while healthcare professionals who do not appear in the file may not have received industry engagement during the quarter.

The combination of hcpbrickmetrics, hcpcompanymetrics, and hcptobrick files joined on the globally unique identifier may answer questions regarding how an organization's access compares with the industry and whether there are healthcare professionals in high-activity groups that are not in the organization's customer relationship management system. The joined data set may enable organizations to identify engagement opportunities by comparing their own engagement metrics against the aggregated channel metrics and by identifying healthcare professionals in high-activity data structures who are not currently engaged by the organization.

The repcountrymetrics file may answer questions regarding the activity volume that representatives have by channel in a week for a country. The representative metrics may indicate the weekly average non-video calls, video calls, sent emails, and opened emails per representative at the country level. The repcountrymetrics file may also answer questions regarding representatives in the eightieth percentile of activity by providing percentile-based metrics that characterize the engagement levels of high-performing representatives. The repcountrymetrics file may answer questions regarding how often closed loop marketing content is used by providing metrics for non-video closed loop marketing calls and video closed loop marketing calls.

The combination of repcountrymetrics and repcompanymetrics files joined on the type indicator may answer questions regarding how the activity volumes of an organization's field teams compare to national benchmarks. Organizations may compare their company representative metrics against the industry representative metrics to assess whether their representatives are performing above or below industry averages for each communication channel. The comparison may inform organizational decisions regarding representative training, performance management, and resource allocation.

While various embodiments have been described above, it should be understood that they have been presented by way of example only, and not limitation. Thus, the breadth and scope of a preferred embodiment should not be limited by any of the above described exemplary embodiments, but should be defined only in accordance with the claims and their equivalents for any patent that issues claiming priority from the present provisional patent application.

In all descriptions of “servers” or other computing devices herein, whether or not the illustrations of those servers or other computing devices similarly show a server-like illustration in the figures, it should be understood that any such described servers or computing devices will similarly per form their described functions in accordance with computer readable instructions stored on a computer-readable media that are connected thereto.

Resources may encompass any types of resources for running instances including hardware (such as servers, clients, mainframe computers, networks, network storage, data sources, memory, central processing unit time, Scientific instruments, and other computing devices), as well as software, software licenses, available network services, and other non-hardware resources, or a combination thereof.

A networked computing environment may include, but is not limited to, computing grid systems, distributed computing environments, cloud computing environment, etc. Such networked computing environments include hardware and Software infrastructures configured to form a virtual organization comprised of multiple resources which may be in geographically disperse locations.

The approved content may be in any format, e.g., text, audio, video, picture, multimedia, or PDF.

Various terms used herein have special meanings within the present technical field. Whether a particular term should be construed as such a “term of art, depends on the context in which that term is used. “Connected to,” “in communication with or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time.” “equivalent,” “during,” “complete,” and the like should be understood to mean “substantially at the time.” “substantially equivalent,” “substantially during,” “substantially complete,” etc., where “substantially” means that such comparisons, measurements, and timings are practicable to accomplish the implicitly or expressly stated desired result.

The steps and/or operations described above in relation to an embodiment of the present disclosure may occur in a different order, or in parallel, or concurrently for different epochs, etc. depending on the specific embodiment and/or implementation, as would be understood by one of ordinary skill in the art. Different embodiments may perform actions in a different order or by different ways or means. As would be understood by one of ordinary skill in the art, some drawings are simplified representations of the actions performed, their descriptions herein simplified overviews, and real-world implementations would be much more complex, require more stages and/or components, and would also vary depending on the requirements of the particular implementation. Being simplified representations, these drawings do not show other required steps as these may be known and understood by one of ordinary skill in the art and may not be pertinent and/or helpful to the present description.

Similarly, some drawings are simplified block diagrams showing only pertinent components, and some of these components merely represent a function and/or operation well-known in the field, rather than an actual piece of hardware, as would be understood by one of ordinary skill in the art. In such cases, some or all of the components/modules may be implemented or provided in a variety and/or combinations of manners, such as at least partially firmware and/or hardware, including, but not limited to one or more application-specific integrated circuits (“ASICS”), standard integrated circuits, controllers executing appropriate instructions, and including microcontrollers and/or embedded controllers, field-programmable gate arrays (“FPGAs”), complex programmable logic devices (“CPLDs”), and the like. Some or all of the system components and/or data structures may also be stored as contents (e.g., as executable or other machine-readable software instructions or structured data) on a non-transitory computer-readable medium (e.g., as a hard disk; a memory; a computer network or cellular wireless network or other data transmission medium; or a portable media article to be read by an appropriate drive or via an appropriate connection, such as a DVD or flash memory device) so as to enable or configure the computer-readable medium and/or one or more associated computing systems or devices to execute or otherwise use or provide the contents to perform at least some of the described techniques.

One or more processors, simple micro controllers, controllers, and the like, whether alone or in a multi-processing arrangement, may be employed to execute sequences of instructions stored on non-transitory computer-readable media to implement embodiments of the present disclosure. In some embodiments, hard-wired circuitry may be used in place of or in combination with software instructions. Thus, embodiments of the present disclosure are not limited to any specific combination of hardware circuitry, firmware, and/or software.

The term “computer-readable medium” as used herein refers to any medium that stores instructions which may be provided to a processor for execution. Such a medium may take many forms, including but not limited to, non-volatile and volatile media. Common forms of non-transitory computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, and EPROM, a FLASH-EPROM, any other memory chip or cartridge, or any other medium on which instructions which can be executed by a processor are stored. The computer readable media does not include carrier waves and electronic signals passing wirelessly or over wired connections.

Additionally, the section headings herein are provided for consistency with the suggestions under 37 CFR 1.77 or otherwise to provide organizational cues. These headings shall not limit or characterize the invention(s) set out in any claims that may issue from this disclosure. Specifically and by way of example, although the headings refer to a “Technical Field, such claims should not be limited by the language chosen under this heading to describe the so-called technical field. Further, a description of a technology in the “Background is not to be construed as an admission that technology is prior art to any invention(s) in this disclosure. Neither is the “Brief Summary” to be considered as a characterization of the invention(s) set forth in issued claims. Furthermore, any reference in this disclosure to “invention’ in the singular should not be used to argue that there is only a single point of novelty in this disclosure. Multiple inventions may be set forth according to the limitations of the multiple claims issuing from this disclosure, and such claims accordingly define the invention(s), and their equivalents, that are protected thereby. In all instances, the scope of such claims shall be considered on their own merits in light of this disclosure, but should not be constrained by the headings set forth herein.

1. A computer-implemented method for generating anonymized structured data matrices
that prevent reverse engineering of individual entity data while preserving data integrity, the method comprising:
receiving, by one or more processors from a plurality of customer relationship management systems, interaction records documenting engagements between representatives of the organizations and healthcare professionals, wherein each interaction record comprises engagement data indicating activities across a plurality of communication channels including at least two of video calls, non-video calls, sent electronic messages, and opened electronic messages;
performing, by the one or more processors, entity resolution by executing a matching algorithm that compares healthcare professional data extracted from the interaction records against reference records stored in a master data management system, wherein the matching algorithm applies country-specific matching criteria to associate a globally unique identifier with each healthcare professional, and wherein the globally unique identifier enables aggregation of interaction records corresponding to a same healthcare professional across the plurality of customer relationship management systems;
segmenting, by the one or more processors, the healthcare professionals into segment groups based on at least one of geographic region and medical specialty;
computing, by the one or more processors, a composite engagement score for each healthcare professional within each segment group by applying weighted values to the engagement data for each of the plurality of communication channels;
sorting, by the one or more processors, the healthcare professionals within each segment group based on the composite engagement scores;
grouping, by the one or more processors, the sorted healthcare professionals into data structures each comprising a fixed number of healthcare professionals having composite engagement scores within a threshold proximity, wherein the fixed number is selected to prevent identification of individual healthcare professional engagement patterns;
computing, by the one or more processors, aggregated channel metrics for each data structure, wherein the aggregated channel metrics comprise an average engagement value for each of the plurality of communication channels calculated across the healthcare professionals within the data structure;
generating, by the one or more processors, an anonymized structured data matrix associating each healthcare professional identifier with the aggregated channel metrics of the corresponding data structure in place of individual engagement values for the healthcare professional; and
storing the anonymized structured data matrix in a non-transitory computer-readable storage medium for access by the organizations to enable comparative analysis of engagement patterns without exposing individual healthcare professional engagement data or proprietary organizational engagement strategies.

2. The computer-implemented method of claim 1, further comprising:
filtering the interaction records to exclude records associated with healthcare professionals having an opt-out status indicator stored in the master data management system; and
performing entity resolution comprises applying a generic matching method for a first set of countries and applying country-specific matching methods for a second set of countries based on regional data availability and naming conventions.

3. The computer-implemented method of claim 2, wherein for healthcare professionals located in the United States, the matching algorithm matches a National Provider Identifier from the interaction records against National Provider Identifier records in the master data management system.

4. The computer-implemented method of claim 2, wherein the matching algorithm compares account data from the customer relationship management systems against reference records using in-memory processing, and wherein the account data is discarded after processing.

5. The computer-implemented method of claim 1, wherein performing entity resolution further comprises executing a stamping process that applies the globally unique identifier to a designated field in each of the plurality of customer relationship management systems for accounts that were previously unmatched.

6. The computer-implemented method of claim 1, wherein the entity resolution is performed on a periodic basis to maintain data accuracy and consistency across the plurality of customer relationship management systems.

7. The computer-implemented method of claim 1, wherein the master data management system stores reference data comprising names, addresses, contact information, medical specialty, license information, industry identifiers, and organizational affiliations for healthcare professionals.

8. The computer-implemented method of claim 1, wherein the fixed number of healthcare professionals in each data structure is five.

9. The computer-implemented method of claim 8, wherein the threshold proximity is determined such that healthcare professionals within each data structure have composite engagement scores that differ by less than a predetermined variance value.

10. The computer-implemented method of claim 1, further comprising: determining, by the one or more processors, whether a data structure exceeds a customer concentration threshold indicating that engagement activity from a single organization exceeds a predetermined percentage of total engagement activity within the data structure; and blocking access to the aggregated channel metrics for the data structure in response to determining that the customer concentration threshold is exceeded.

11. The computer-implemented method of claim 10, further comprising: determining, by the one or more processors, whether a data structure has interaction records from fewer than a minimum number of organizations; and blocking access to the aggregated channel metrics for the data structure in response to determining that the data structure has interaction records from fewer than the minimum number of organizations.

12. The computer-implemented method of claim 1, wherein computing the composite engagement score comprises applying a first weight to video call activities, a second weight to non-video call activities, a third weight to sent electronic message activities, and a fourth weight to opened electronic message activities.

13. The computer-implemented method of claim 1, further comprising computing, by the one or more processors, industry-level metrics at a country level and a specialty level by aggregating the engagement data across all healthcare professionals within the respective country or specialty.

14. The computer-implemented method of claim 1, further comprising freezing, by the one or more processors, the interaction records and the computed aggregated channel metrics at predetermined quarterly intervals to preserve data integrity for comparative analysis across different time periods.

15. A system for generating anonymized structured data matrices that prevent reverse engineering of individual entity activities while enabling comparative analysis of engagement patterns, the system comprising:
one or more processors;
a master data management system;
one or more customer relationship management systems wherein each customer relationship management system corresponds to a different organization;
a non-transitory computer-readable memory coupled to the one or more processors and storing instructions that, when executed by the one or more processors, cause the system to perform operations comprising:
receiving interaction records documenting engagements between representatives of the organizations and healthcare professionals, wherein each interaction record comprises engagement data indicating activities across a plurality of communication channels including at least two of video calls, non-video calls, sent electronic messages, and opened electronic messages;
performing entity resolution by executing a matching algorithm that compares healthcare professional data extracted from the interaction records against reference records stored in the master data management system, wherein the matching algorithm applies country-specific matching criteria to associate a globally unique identifier with each healthcare professional, and wherein the globally unique identifier enables aggregation of interaction records corresponding to a same healthcare professional across the plurality of customer relationship management systems;
filtering the interaction records to exclude records associated with healthcare professionals having an opt-out status indicator stored in the master data management system; segmenting the healthcare professionals into segment groups based on at least one of geographic region and medical specialty;
computing a composite engagement score for each healthcare professional within each segment group by applying weighted values to the engagement data for each of the plurality of communication channels;
sorting the healthcare professionals within each segment group based on the composite engagement scores;
grouping the sorted healthcare professionals into data structures each comprising a fixed number of healthcare professionals having composite engagement scores within a threshold proximity, wherein the fixed number is selected to prevent identification of individual healthcare professional engagement patterns;
computing aggregated channel metrics for each data structure, wherein the aggregated channel metrics comprise an average engagement value for each of the plurality of communication channels calculated across the healthcare professionals within the data structure; generating an anonymized structured data matrix associating each healthcare professional identifier with the aggregated channel metrics of the corresponding data structure in place of individual engagement values for the healthcare professional; and
storing the anonymized structured data matrix in a storage device for access by the organizations to enable comparative analysis of engagement patterns without exposing individual healthcare professional engagement data or proprietary organizational engagement strategies.

16. The system of claim 15, wherein the operations further comprise: determining whether a data structure exceeds a customer concentration threshold indicating that engagement activity from a single organization exceeds a predetermined percentage of total engagement activity within the data structure; and blocking access to the aggregated channel metrics for the data structure in response to determining that the customer concentration threshold is exceeded.

17. The system of claim 16, wherein the operations further comprise: determining whether a data structure has interaction records from fewer than a minimum number of organizations; and blocking access to the aggregated channel metrics for the data structure in response to determining that the data structure has interaction records from fewer than the minimum number of organizations.

18. The system of claim 15, wherein the operations further comprise generating scrambled customer identifiers for each organization by applying a hash function to an anonymized customer identifier, wherein the scrambled customer identifiers are included in output files to maintain organization anonymity.

19. A non-transitory computer-readable medium storing instructions that, when executed by one or more processors, cause the one or more processors to perform operations comprising:
receiving, from a plurality of customer relationship management systems operated by different organizations, interaction records documenting engagements between representatives of the organizations and healthcare professionals, wherein each interaction record comprises engagement data indicating activities across a plurality of communication channels;
performing entity resolution by executing a matching algorithm that compares healthcare professional data extracted from the interaction records against reference records stored in a master data management system to associate a globally unique identifier with each healthcare professional, wherein the globally unique identifier enables aggregation of interaction records corresponding to a same healthcare professional across the plurality of customer relationship management systems;
filtering the interaction records to exclude records associated with healthcare professionals having an opt-out status indicator; computing a composite engagement score for each healthcare professional by applying weighted values to the engagement data for each of the plurality of communication channels; grouping the healthcare professionals into data structures each comprising a fixed number of healthcare professionals having composite engagement scores within a threshold proximity, wherein the fixed number is selected to prevent identification of individual healthcare professional engagement patterns; computing aggregated channel metrics for each data structure comprising an average engagement value for each of the plurality of communication channels calculated across the healthcare professionals within the data structure;
generating an anonymized structured data matrix associating each healthcare professional identifier with the aggregated channel metrics of the corresponding data structure in place of individual engagement values; and storing the anonymized structured data matrix for access by the organizations to enable comparative analysis of engagement patterns without exposing individual healthcare professional engagement data or proprietary organizational engagement strategies.

20. The non-transitory computer-readable medium of claim 19, wherein the operations further comprise generating a plurality of metric files at different granularities comprising at least a data structure metrics file, a country metrics file, a specialty metrics file, and a company metrics file.
